(19) United States
(12) Patent Application Publication
(10) Pub. No.: US 2026/0085138 A1
(43) Pub. Date: Mar. 26, 2026

(54) REPROCESSABLE POLYMERS AND METHODS FOR THE MANUFACTURE THEREOF

(71) Applicant: University of Massachusetts, Westborough, MA (US)

(72) Inventors: Reika Katsumata, Worcester, MA (US); Autumn M. Mineo, Sturbridge, MA (US)

(21) Appl. No.: 18/896,280

(22) Filed: Sep. 25, 2024

Related U.S. Application Data
(60) Provisional application No. 63/541,397, filed on Sep. 29, 2023.

(51) Int. Cl. C08F 220/14; C08J 11/16; C08J 11/22; C08J 11/28; C08K 3/30; C08K 5/14; C08K 5/23

(52) U.S. Cl. CPC C08F 220/14; C08J 11/16; C08J 11/22; C08J 11/28; C08K 3/30; C08K 5/14; C08K 5/23; C08F 2438/01; C08F 2438/03; C08J 2381/04; C08K 2003/3045

(57) ABSTRACT

A polymer including repeating units derived from an ethylenically unsaturated monomer and a cyclic allyl sulfide is described herein. The polymer advantageously is reprocessable. Methods for the manufacture of the polymer as well as methods for reprocessing the polymer are also described.

### CROSS REFERENCE TO RELATED APPLICATION

This application claims priority to and the benefit of U.S. Provisional Application No. 63/541,397, filed on Sep. 29, 2023, the contents of which are hereby incorporated by reference in their entirety.

### BACKGROUND

As commodity materials, large volumes of vinyl-derived polymers are produced globally. Despite their prevalence, after-use care of these materials is lacking. Once formed, these polymers are challenging to chemically recycle, stemming from their carbon-carbon backbone connectivity, which restricts alteration to a few energy-intensive processes, such as heating above a ceiling temperature, pyrolysis, or incineration, resulting in complex product mixtures not suitable for direct repolymerization. Without chemical means, mechanical reprocessing, involving heating materials above thermal transitions and consequent re-extrusion or shaping, allows for post-consumer material to be repurposed. However, cycling through the harsh conditions used during mechanical recycling results in uncontrolled chain scission, and ultimately the deterioration of material properties, such as modulus, with cycle number.

Previous work has considered the implications of copolymerizing conventional vinyl monomers with comonomer additives designed to offer site-specific scission, typically through nucleophilic attack of an ester or ester derivative. Commercial copolymerization is already conducted to modify material properties of base homopolymers, for instance in the field of rubbers, and thermoplastic elastomers.

Accordingly, there remains a continuing need for improved methods and compositions to facilitate recycling of polymer materials. It would be particularly advantageous to provide new recyclable materials through copolymerization with cleavable comonomer additives without compromising thermomechanical properties.

### SUMMARY

An aspect of the present disclosure is a polymer comprising repeating units derived from an ethylenically unsaturated monomer and a cyclic allyl sulfide, wherein the repeating units derived from the cyclic allyl sulfide are of the structure

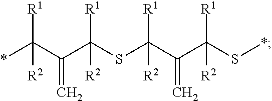

wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

Another aspect is a method for the manufacture of the polymer, the method comprising: contacting an ethylenically unsaturated monomer, and a cyclic allyl sulfide of the formula

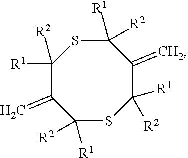

in the presence of a free radical initiator to provide the polymer; wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

Another aspect is a method for reprocessing the polymer, the method comprising: contacting the polymer with a thiol-containing compound in the presence of a free radical initiator to provide a polymeric chain scission product.

The above described and other features are exemplified by the following figures and detailed description.

### BRIEF DESCRIPTION OF THE DRAWINGS

The following figures represent exemplary embodiments.

FIG. 1 illustrates use of dynamic addition fragmentation transfer chemistry of allyl sulfides for chain scission and chain extension according to an aspect of the present disclosure.

FIG. 2 illustrates thermally initiated radical scission reaction with 7-bis(methylene)-1,5-dithiacyclooctane (BMDTO) containing copolymers and allyl dithiol.

FIG. 3 shows gel permeation chromatography (GPC) traces of poly(methyl methacrylate) PMMA copolymers with varying concentrations of BMDTO. Peak molecular weight (Mp) values are included above the trace peak.

FIG. 4 shows scission fragment molecular weight relative to initial molecular weight (determined by GPC), where histogram box represents the variation in number average molecular weight (Mn) to Mn, weight average molecular weight (Mw) to Mw, and peak of the distribution Mp to Mp (asterisk indicates a sample with non-uniform distribution of BMDTO in the starting copolymer resulting in a bimodal scission product).

FIG. 5 shows relationship between scission fragment size (Mp, kilodaltons (kDa)) and the molar percent of BMDTO in the initial copolymer.

FIG. 6 shows exemplary conditions for chain extension according to an aspect of the disclosure.

FIG. 7 shows a summary of results of extension experiments conducted where the weight percent of scission fragments and the molar equivalence of vinyl monomer added are labeled.

FIG. 8 shows a relationship between scission fragment loading and the observed change in chain extension. Asterisk indicates sample was underwent extension without additional BMDTO added.

FIG. 9 shows demonstration of cycling and the fluctuations in dispersity as a result of cycling through scission and extension cycles.

FIG. 10 shows demonstration of successful extension without replenishment of BMDTO additive.

FIG. 11 shows demonstration of block copolymer synthesis through chain extension of scission fragments.

FIG. 12 shows a plot of copolymerization behavior of BMDTO with MMA by ATRP and RAFT compared to FRP methods. ATRP NBD PMMAB copolymer sample is initiated with fluorophore, nitrobenzoxadiazole (NBD). Inset box and whisker plot suggesting increased BMDTO copolymerization with controlled radical techniques. Error bars indicate the lowest and highest value.

FIG. 13 shows a plot of molar mass of controlled radical products remain low. Inset shows dispersity of controlled radical products are only marginally reduced compared to FRP products.

FIG. 14 shows normalized molar mass after radical scission reveals comparable scission between all copolymers. FBMDTO for each initial copolymer is included below each box and whisker plot, representing each element of the molar mass distribution (Mp, Mn, Mw) relative to itself after scission. Error bars indicate the lowest and highest value.

FIG. 15 shows molar mass as a function of BMDTO repeat unit abundance. Emulsion products are substantially offset from free radical products, where emulsion copolymers have increased molar mass at high BMDTO abundance.

FIG. 16 shows normalized molar mass after radical scission reveals comparable scission between all copolymers. FBMDTO for each initial copolymer is included below each box and whisker plot, representing each element of the molar mass distribution (Mp, Mn, Mw) relative to itself after scission. Error bars indicate the lowest and highest value.

FIG. 17 shows normalized molar mass after radical scission reveals comparable scission between all copolymers. FBMDTO for each initial copolymer is included below each box and whisker plot, representing each element of the molar mass distribution (Mp, Mn, Mw) relative to itself after scission. Error bars indicate the lowest and highest value.

FIG. 18 shows force required for sustained incremental peel in hanging weight peel experiments.

FIG. 19 shows peel force normalized by weld width and peel angle in hanging weight peel experiments.

FIG. 20 shows results from double cantilever beam testing. Characteristic crack length observed in PS-PS sample from three discrete times during experiment, in PS-PMMA sample from three discrete frames during experiment, and in PSB_{2.66}-EE RAFT PMMAB_{3.40} sample from one time point during experiment due to sample coming out of focus (left). Critical strain energy release rate derived from the crack length measurements (right).

### DETAILED DESCRIPTION

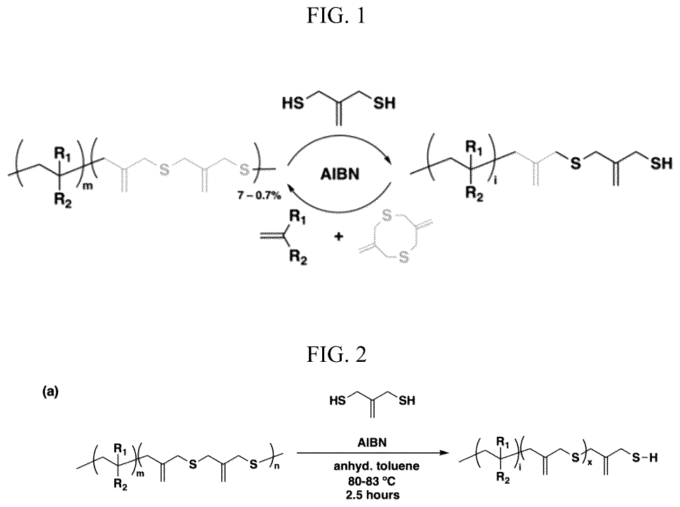

In contrast to previous work with comonomer additives, the present inventors sought to develop a versatile additive which would enable vinyl-derived polymers to cleave into fragments with end groups that could be subsequently activated to enable chain extension, similar to the behavior of a macromolecular chain transfer agent, for example as shown in FIG. 1. Dissimilar to recycling efforts with ester and ester derivatives, the present method does not involve nucleophilic attack for chain scission and allows for direct radical repolymerization. In this way, the recycled product could be structurally equivalent to the original copolymer. Advantageously, copolymers could be synthesized with allyl sulfide repeat units preserved in the backbone of vinyl-derived polymers through radical ring-opening polymerizations of cyclic allyl sulfides (CASs), and the incorporation of CASs can be much greater than that of cyclic ketene acetals without cumbersome hydrolysis concerns, and offer stability under caustic and alkaline conditions, compatible with diverse packaging requirements.

Specifically, the present inventors have found that an 8-membered CAS, 3,7-bismethylene-1,5-dithiacyclooctane (BMDTO) can be incorporated as a comonomer additive into polymers with various monomers including styrene, methyl methacrylate, butyl methacrylate, methyl acrylate, 2-vinyl pyridine, and 2-vinyl-4,4-dimethyl azlactone, resulting in copolymers with varying molecular weights (e.g., ranging from >150-20 kDa) and BMDTO incorporation (e.g., 0.7-13 mole percent (mol %) BMDTO). It was found that BMDTO incorporation to the thermal decomposition of these polymers in this loading range yielded minimal implications, and noted the depression in the glass transition, as well as the emergence of new proton environments indicative of BMDTO-monomer dyad indicate successful copolymerization. Ring-opened BMDTO possesses continued proclivity for radical rearrangement through addition-fragmentation-transfer (AFT), which could be leveraged to cleave polymer chains under radical conditions in the presence of a thiol source, acting as a transfer agent/radical cap. Allyl dithiol was chosen as an exemplary transfer agent for chain scission in order to preserve allyl thiol functionality during fragmentation. Copolymers of BMDTO and methyl methacrylate, styrene, butyl methacrylate, and methyl acrylate all demonstrated chain scission, resulting in fragments ranging from 39-14% of the initial copolymer size, depending on the amount of BMDTO in the copolymer. Importantly, homopolymer control samples showed no change in molecular weight following analogous conditions, confirming the scission was site specific to the BMDTO repeat units in the copolymer samples. The allyl sulfide-allyl thiol terminated fragments formed through radical scission could undergo subsequent chain extension when initiated in the presence of additional monomer. Chain extension was visualized by dual detection gel permeation chromatography and verified the UVB-active fragment distribution shifted to shorter retention times (higher molecular weight) following extension reaction conditions. The extent of chain extension is correlated to the amount of monomer added relative to the scission fragment. In a further advantageous feature, successful chain extension with styrene, methyl methacrylate, butyl methacrylate, and methyl acrylate fragments, with extensions ranging from 1.25 to 11.5 times the size of the scission product was demonstrated. Preliminary cycling studies on styrene and methyl methacrylate samples demonstrate repeatable scission and extension through two cycles without run away dispersity escalation. Finally, successful block copolymer generation through chain extension of either methyl methacrylate or styrene off of styrene or methyl methacrylate scission fragments respectively was demonstrated. The synthesis of block copolymers in this manner represents an instance of upcycling from a recycled fragment to an attractive material outside of commodity plastics. A significant improvement is therefore provided by the present disclosure.

Accordingly, an aspect of the present disclosure is a polymer comprising repeating units derived from an ethylenically unsaturated monomer and a cyclic allyl sulfide.

The ethylenically unsaturated monomer is not particularly limited provided that it is capable of undergoing a free radical polymerization. For example, the ethylenically unsaturated monomer can be a vinyl monomer, a styrenic monomer, a (meth)acrylate monomer, a (meth)acrylamide monomer, or an olefin.

In an aspect, the ethylenically unsaturated monomer can comprise a (meth)acrylate monomer, for example a C₁₋₂₄ alkyl (meth)acrylate, a hydroxy C₁₋₂₄ alkyl (meth)acrylate, or an ionic (meth)acrylate such as acid containing (meth)acrylates, amine containing (meth)acrylates, and amide containing (meth)acrylates. C₁₋₂₄ alkyl(meth)acrylates can include, but are not limited to, methyl (meth)acrylate, ethyl (meth)acrylate, butyl (meth)acrylate, 2-ethylhexyl (meth)acrylate, decyl (meth)acrylate, lauryl (meth)acrylate, stearyl (meth)acrylate, and combinations thereof. Exemplary hydroxyalkyl (meth)acrylates can include hydroxyethyl (meth)acrylate and hydroxypropyl (meth)acrylate. In an aspect, the ethylenically unsaturated monomer can comprise a C₁₋₁₈ (meth)acrylate monomer, or a C₁₋₁₂ (meth)acrylate monomer, or a C₁₋₆ (meth)acrylate monomer.

Examples of other ethylenically unsaturated monomers are acid-containing monomers including acid-containing (meth)acrylates such as (meth)acrylic acid.

In an aspect, the ethylenically unsaturated monomer can comprise a styrenic monomer. Styrenic monomers include styrene and substituted styrenes having one or more alkyl, alkoxyl, hydroxyl or halo substituent group attached to the aromatic ring, including, e.g., -methyl styrene, p-methyl styrene, vinyl toluene, vinyl xylene, trimethyl styrene, butyl styrene, chlorostyrene, dichlorostyrene, bromostyrene, p-hydroxystyrene, methoxystyrene and vinyl-substituted condensed aromatic ring structures, such as, e.g., vinyl naphthalene, vinyl anthracene, as well as mixtures of vinyl aromatic monomers. The styrene and substituted styrenes mentioned above can also have C₁₋₆ alkyl, chloro-, bromo, or nitro-groups in the α-position of the vinyl functionality. In an aspect, the ethylenically unsaturated monomer can comprise styrene.

In an aspect, the ethylenically unsaturated monomer can comprise a vinyl monomer, for example a vinyl ester (e.g., vinyl acetate), vinyl chloride, vinylidene chloride, N-vinyl pyrrolidone, 2-vinyl dimethyl azlactone, and the like or a combination thereof.

Olefinic monomers can include, for example, ethylene, propylene, a linear C₄₋₂₄ alpha olefin, or a branched C₄₋₂₄ alpha olefin. Ethylene and propylene are mentioned.

In an aspect a combination of any of the foregoing ethylenically unsaturated monomers can be used.

In addition to repeating units derived from the ethylenically unsaturated monomer, the polymer further comprises repeating units derived from a cyclic allyl sulfide. The repeating units derived from the cyclic allyl sulfide are of the structure

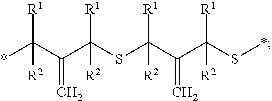

wherein R¹ and R² are independently at each occurrence hydrogen, a substituted or unsubstituted C₁₋₆ alkyl group, a halogen, or R¹ and R² on a single carbon atom are taken together with the carbon atom to form a carbonyl group (i.e., —(C═O)—), and the “*” indicates the point of attachment to the rest of the polymer backbone.

In an aspect, R¹ and R² are hydrogen at each occurrence. In an aspect, R¹ and R² are independently at each occurrence hydrogen or substituted or unsubstituted C₁₋₆ alkyl. For example, at least one, two, three, or four of the R¹ groups and at least one, two, three, or four of the R² groups can be a substituted or unsubstituted C₁₋₆ alkyl group, with the remainder of the R¹ and R² groups being hydrogen. In an aspect, when any occurrences of R¹ and R² are a substituted or unsubstituted C₁₋₆ alkyl group, unsubstituted C₁₋₆ alkyl groups may be preferred, for example a methyl group or an ethyl group. In an aspect, at least one occurrence of R¹ and R² on a single carbon atom can be taken together with the corresponding carbon atom to form a carbonyl group (i.e., —(C═O)—). As the carbonyl group (when present) is adjacent to a sulfur atom, it will be understood that this represents a thioester group. It will be recognized that when a thioester group is present, subsequent polymer chain scission may include nucleophilic scission at the thioester group.

In a specific aspect, R¹ and R² are hydrogen at each occurrence and the repeating units derived from the cyclic allyl sulfide are of the structure

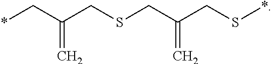

The repeating units derived from the cyclic allyl sulfide are present in the polymer in an amount of 0.1 to 50 mole percent. For example, within this range, the repeating units derived from the cyclic allyl sulfide can be present in an amount of 0.1 to 25 μmole percent, or 0.1 to 15 μmole percent, for example 0.5 to 15 μmole percent, for example 0.7 to 13 mole percent. Above 50 mole percent, the polymer may not exhibit a desirable combination of properties, for example suitable solubility or thermal stability.

The polymer can have a peak molecular weight (Mp) of 1,000 to 500,000 grams per mole. Within this range, the polymer can have an Mp of 1,000 to 250,000 grams per mole, or 1,000 to 200,000 grams per mole, or 1,000 to 175,000 grams per mole, or 1,000 to 160,000 grams per mole, or 1,000 to 150,000 grams per mole, or 1,000 to 125,000 grams per mole, or 1,000 to 100,000 grams per mole, or 1,000 to 75,000 grams per mole, or 1,000 to 65,000. Peak molecular weight (Mp) can be determined by gel permeation chromatography. In an aspect, the polymer can have a number average molecular weight of 1,000 to 100,000 grams per mole, or 5,000 to 100,000 grams per mole, or 1,000 to 50,000 grams per mole, or 5,000 to 50,000 grams per mole, or 25,000 to 100,000 grams per mole. In an aspect, the polymer can have a weight average molecular weight of 25,000 to 200,000 grams per mole, or 25,000 to 100,000 grams per mole, or 25,000 to 75,000 grams per mole, or 75,000 to 200,000 grams per mole, or 100,000 to 200,000 grams per mole, or 125,000 to 200,000 grams per mole. Gel permeation chromatography can be, for example, using dimethylformamide (DMF) or tetrahydrofuran (THF) as eluents, and relative to polystyrene or poly(methyl methacrylate) standards. Suitable solvents and standards may vary based on the solubility of the particular polymer being characterized, and such conditions can be selected by the skilled person guided by the present disclosure. Additional details on molecular weight characterization are further described in the working examples below. In some aspects, the method by which the polymer is prepared can lead to variation in molecular weight, as further described in the working examples below.

The polymer can be made by a free radical polymerization process of the ethylenically unsaturated monomer and the cyclic allyl sulfide. For example, the method of making the polymer can comprise contacting the ethylenically unsaturated monomer and the cyclic allyl sulfide in the presence of a free radical initiator to provide the polymer. The cyclic allyl sulfide can be of the formula

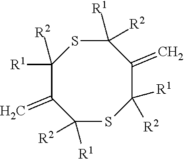

wherein R¹ and R² can be as defined above. In a specific aspect, each occurrence of R¹ and R² can be hydrogen, and the cyclic allyl sulfide can be of the formula

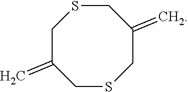

The free radical initiator is not particularly limited and can be a compound capable of producing a radical in response to an applied stimulus (e.g., heat, light, or both). In an aspect the free radical initiator can be thermally activated.

Exemplary free radical initiators can include an organic peroxide compound (e.g., benzoyl peroxide); a persulfate compound (e.g., potassium persulfate); or an azonitrile compound (e.g., 2,2′-azobis-2,3,3-trimethylbutyronitrile or 2,2′-azobis-2-methylpropionitrile). In an aspect, the initiator is a an azonitrile compound. In some aspects, the process can be a controlled free radical process, such as atom transfer radical polymerization (ATRP) or reversible addition-fragmentation transfer (RAFT) polymerization. Suitable radical initiators and chain transfer agents (for RAFT) are generally known and can be selected by the skilled person guided by the present disclosure. In some aspects, it can be advantageous to employ an emulsion polymerization process. For example, in an aspect, the polymer resulting from an emulsion polymerization can have a molecular weight that is greater than a corresponding polymer prepared using a non-emulsion free radical polymerization process. For example, the polymer resulting from an emulsion polymerization can have a number average molecular weight of 25 to 100 kDa, and a weight average molecular weight of 50 to 200 kDa. Additional process details are further described in the working examples below.

The polymerization can be carried out in a suitable solvent or as a bulk polymerization (i.e., in the absence of a solvent). When a solvent is used, the solvent can be an organic solvent in which the components of the reaction mixture are soluble. Suitable solvents can therefore vary depending on the chemical identity of the ethylenically unsaturated monomer or the free radical initiator. The solvent can also depend on the reaction temperature. For example, a solvent should be selected such that the boiling point of the solvent is less than the reaction temperature (e.g., the temperature necessary to decompose the free radical initiator when a thermal initiator is used). In an aspect, the reaction can be conducted as a bulk polymerization.

In an aspect, the method can be conducted at a temperature effective to decompose the free radical initiator and provide the necessary radicals to propagate the reaction. For example, the method can be conducted at a temperature of 20 to 200° C., or 25 to 150° C., or 30 to 125° C., or 40 to 100° C., or 50 to 100° C., or 65 to 100° C., or 70 to 90° C. In an aspect, the reaction can be conducted at atmospheric pressure, though higher and lower pressures are also contemplated.

The polymer described herein can be reprocessed or recycled. In an advantageous feature, the mechanism for reprocessing of the polymer does not rely on nucleophilic attack of groups such as ester groups or thioester groups. Accordingly, the polymer described herein can exclude ester groups or thioester groups present in the backbone polymer chain. Stated another way, the main chain of the polymer backbone may include only carbon-carbon (C—C) bonds and carbon-sulfur (C—S) bonds.

A method for reprocessing the polymer therefore represents another aspect of the present disclosure. The method can comprise contacting the polymer with a thiol-containing compound in the presence of a free radical initiator to provide a polymeric chain scission product. As used herein, the term “polymeric chain scission product” refers to a fragment of the initial polymer (i.e., prior to reaction with the thiol-containing compound in the presence of a free radical initiator).

Suitable free radical initiators can be as described above in the context of the polymerization. Exemplary free radical initiators can include an organic peroxide compound (e.g., benzoyl peroxide); a persulfate compound (e.g., potassium persulfate); or an azonitrile compound (e.g., 2,2′-azobis-2,3,3-trimethylbutyronitrile or 2,2′-azobis-2-methylpropionitrile). In an aspect, the initiator is a an azonitrile compound.

The thiol-containing compound can generally be any compound which has at least one thiol group. In an aspect, the thiol-containing compound has one thiol group (e.g., a C₁₋₁₂ alkyl thiol). In an aspect, the thiol-containing compound has two thiol groups. In an aspect, the thiol-containing compound has three or more thiol groups, for example for thiol groups. In an aspect, the thiol-containing compound is preferably a discrete small molecule (i.e., not an oligomer or polymer), and can have, for example, a molecular weight of 500 grams per mole or less, or 250 grams per mole or less, or 150 grams per mole or less.

In an aspect, the thiol-containing compound is a di-thiol (i.e., having two thiol groups). For example, the thiol-containing compound can be of the formula HS-L-SH, wherein L is an organic linking group, for example a C₁₋₂₀ hydrocarbyl group. In a specific aspect, the thiol-containing compound can be an allyl di-thiol (i.e., containing at least one allyl thiol moiety) of the structure

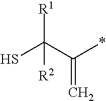

wherein R¹ and R² can be as defined above, and the “*” represents a point of attachment to the rest of the compound). In an aspect, each of R¹ and R² can be hydrogen and the thiol-containing compound can include at least one allyl thiol moiety of the structure

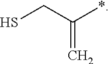

In a specific aspect, the thiol-containing compound can be an allyl di-thiol of the structure

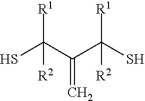

wherein R¹ and R² can be as define above. In an aspect, each of R¹ and R² can be hydrogen and the allyl di-thiol can be of the structure

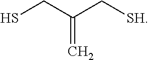

Reaction of the initial polymer, the thiol-containing compound, and the free radical initiator provide a polymer chain scission product. In an aspect, in particular when the thiol-containing compound is a mono-thiol compound or a di-thiol compound, the reaction can be a depolymerization, wherein the initial polymer is broken down into lower molecular weight fragments. For example, the polymeric chain scission product has a peak molecular weight (Mp) that is less than a peak molecular weight of the initial polymer (i.e., prior to the reaction with the thiol-containing compound and the free radical initiator); a molecular weight distribution (D) that is broader than a molecular weight distribution of the initial polymer; or both. In an aspect, the polymeric chain scission product has a peak molecular weight (Mp) that is 5 to 90%, or 10 to 75%, or 10 to 50% of the peak molecular weight of the initial polymer.

In an aspect wherein the thiol-containing compound is a di-thiol, the polymeric chain scission product comprises at least one thiol end group. This can be advantageous as the thiol end group can provide a reactive handle for further functionalization or repolymerization as further discussed in detail below. In some aspects, the polymeric chain scission product comprises two thiol end groups (i.e., one at each end of the linear polymer chain). In an aspect, the polymer chain scission product can comprise a mixture of polymer chain scission products comprising one or two thiol end groups.

In an aspect, the thiol-containing compound comprises three or more thiol groups, preferably four thiol groups, and the polymer chain scission product can be a crosslinked network.

The thiol-containing compound can be combined with the polymer in an amount of 0.5 to 5 μmolar equivalents with respect to moles of incorporated cyclic allyl thiol, for example 1 to 3 molar equivalents, or 1.5 to 3 molar equivalents, or 2 to 3 molar equivalents.

The chain scission reaction can be carried out in a suitable solvent or as a bulk reaction (i.e., in the absence of a solvent). When a solvent is used, the solvent can be an organic solvent in which the components of the reaction mixture are soluble. Suitable solvents can therefore vary depending on the chemical identity of the initial polymer or the free radical initiator. The solvent can also depend on the reaction temperature. For example, a solvent should be selected such that the boiling point of the solvent is less than the reaction temperature (e.g., the temperature necessary to decompose the free radical initiator when a thermal initiator is used). In an aspect, the reaction can preferably be conducted as a bulk reaction in the absence of a solvent.

In an aspect, the chain scission reaction can be conducted at a temperature effective to decompose the free radical initiator and provide the necessary radicals to effect the chain scission. For example, the method can be conducted at a temperature of 20 to 200° C., or 25 to 150° C., or 30 to 125° C., or 40 to 100° C., or 50 to 100° C., or 65 to 100° C., or 70 to 90° C. In an aspect, the chain scission reaction can be conducted at atmospheric pressure, though higher and lower pressures are also contemplated.

Advantageously, when the polymer chain scission product comprises linear polymer fragments, each comprising at least one thiol end group, the polymer chain scission product can be repolymerized. In an aspect, the method can therefore further comprise contacting the polymeric chain scission product with an ethylenically unsaturated monomer, a cyclic allyl sulfide of the structure

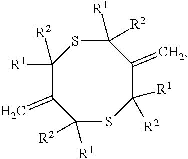

or a combination thereof in the presence of a free radical initiator to provide a chain-extended polymer product. In the foregoing formula, R¹ and R² can be as described above. Preferably, each occurrence of R¹ and R² is hydrogen. In an aspect, the polymeric chain scission product can be contacted with the ethylenically unsaturated monomer and the cyclic allyl sulfide in the presence of the free radical initiator. In an aspect, the ethylenically unsaturated monomer can be selected so as to match the repeating units derived from the ethylenically unsaturated monomer of the polymer chain scission product. Stated another way, the ethylenically unsaturated monomer used for the repolymerization can be the same as the ethylenically unsaturated monomer of the polymer prior to chain scission. Such a repolymerization reaction can effectively provide a chain-extended polymer product having a chemical structure that is substantially identical to the initial polymer prior to chain scission. In another aspect, the ethylenically unsaturated monomer can be different from the ethylenically unsaturated monomer of the polymer prior to chain scission. Such a repolymerization can provide a chain-extended polymer product having a chemical structure that is different from the initial polymer prior to chain scission.

The free radical initiator used for a repolymerization step can be the same as described previously for the initial polymerization and the chain scission reaction. Exemplary free radical initiators can include an organic peroxide compound (e.g., benzoyl peroxide); a persulfate compound (e.g., potassium persulfate); or an azonitrile compound (e.g., 2,2′-azobis-2,3,3-trimethylbutyronitrile or 2,2′-azobis-2-methylpropionitrile). In an aspect, the initiator is a an azonitrile compound.

The repolymerization reaction can be carried out in a suitable solvent or as a bulk reaction (i.e., in the absence of a solvent). When a solvent is used, the solvent can be an organic solvent in which the components of the reaction mixture are soluble. Suitable solvents can therefore vary depending on the chemical identity of the polymer chain scission product, the ethylenically unsaturated monomer, or the free radical initiator. The solvent can also depend on the reaction temperature. For example, a solvent should be selected such that the boiling point of the solvent is less than the reaction temperature (e.g., the temperature necessary to decompose the free radical initiator when a thermal initiator is used). In an aspect, the reaction can preferably be conducted as a bulk polymerization in the absence of a solvent.

In an aspect, the repolymerization reaction can be conducted at a temperature effective to decompose the free radical initiator and provide the necessary radicals to propagate the repolymerization. For example, the method can be conducted at a temperature of 20 to 200° C., or 25 to 150° C., or 30 to 125° C., or 40 to 100° C., or 50 to 100° C., or 65 to 100° C., or 70 to 90° C. In an aspect, the repolymerization reaction can be conducted at atmospheric pressure, though higher and lower pressures are also contemplated.

The chain-extended polymer product can have a peak molecular weight that is 1.1 to 15 times the peak molecular weight of the polymeric chain scission product, for example a peak molecular weight that is 1.25 to 12 times the peak molecular weight of the polymeric chain scission product. In an aspect, the chain-extended polymer product can have a peak molecular weight that is within 20% of the peak molecular weight of the initial polymer, for example within 10%, or within 5%.

The polymer according to the present disclosure can also be used to provide enhanced adhesion between substrates by ultrasonic welding. Accordingly, another aspect of the present disclosure is a method of adhering a first polymer substrate to a second polymer substrate.

The polymer of the first polymer substrate is different from the polymer of the second polymer substrate. Preferably the polymer of the first polymer substrate is immiscible with the polymer of the second polymer substrate. In a specific aspect, the polymer of the first substrate can comprise poly(methyl methacrylate) and the polymer of the second substrate can comprise polystyrene. In a specific aspect, the polymer of the first substrate is a copolymer derived from a first ethylenically unsaturated monomer and from a cyclic allyl sulfide, and the polymer of the second substrate is a copolymer derived from a second ethylenically unsaturated monomer and a cyclic allyl sulfide, wherein the corresponding homopolymer derived from the first ethylenically unsaturated monomer is immiscible with the corresponding homopolymer derived from the second ethylenically unsaturated monomer. The polymer of at least one of the first substrate and the second substrate further comprises an end group that is susceptible to formation of a radical species when subjected to ultrasonic conditions. In a specific aspect, the end group can be a dithiobenzoate group. Other end groups are also contemplated by the present disclosure.

The method comprises positioning the first substrate and the second substrate such that at least a portion of the first substrate overlaps and is in contact with at least a portion of the second substrate, and subjecting the overlapping portions to ultrasonic welding.

Without wishing to be bound by theory, it is believed that the first and second polymer can react upon radical generation to form a block copolymer compatibilizer in situ. Advantageously, the ultrasonically welded substrates can exhibit improved peel force compared to a welded material where the polymer does not include repeating units derived from cyclic allyl sulfide. A significant improvement in welding incompatible materials is therefore provided by the present disclosure.

This disclosure is further illustrated by the following examples, which are non-limiting.

### EXAMPLES

### 3,7-Bis(methylene)-1,5-dithiacycloctane (BMDTO) Synthesis

A clean dry 500 mL single neck round bottom flask equipped with a magnetic stir bar was charged with 1,8-diazabicyclo[5.4.0]-7-undecene (8.7419 g, 57.4 mmol, 0.48 M in reaction) and absolute ethanol (10 mL). The reaction flask was placed under nitrogen and the solution was allowed to stir as allyl dithiol (1.298 g, 10.8 mmol, 1 eq) diluted in absolute ethanol (10 mL) was added. After ten minutes, the majority of the absolute ethanol was added (90 mL) to achieve appropriately dilute conditions. 3-chloro-1-chloromethyl-1-propene (1.361 g, 10.9 mmol, 1.01 eq) was diluted in absolute ethanol (10 mL) and added dropwise to the stirring reaction flask. The reaction was allowed to stir at room temperature and after fifteen minutes the reaction became cloudy. After at least 48 hours, the reaction was reduced to remove as much ethanol as possible, resulting in a cloudy oil, which was resuspended in a solution of ethyl acetate (225 μmL) and diethyl ether (75 μmL). The suspension was washed with sulfuric acid (2.4 M, 150 mL×4) and saturated brine (100 mL×2), resulting in clarity in the aqueous and organic layers with a white precipitate forming at their interface. The organics layer was collected with the white precipitate, then gravity filtered, washing the precipitate with diethyl ether (50 mL). The organic layer was dried with magnesium sulfate, vacuum filtered, and concentrated under reduced pressure. The cloudy concentrated oil was then passed through a short basic alumina (0.5 μmL) plugged syringe column to afford 3,7-bis(methylene)-1,5-dithiacycloctane (BMDTO) as a clear oil (1.5174 g, 81%).

### Polymerization

BMDTO was first homopolymerized to determine basic characteristics. It was found that rigorous degassing techniques were required for successful conversion of BMDTO to poly(BMDTO), even under bulk conditions. The resultant solid was an insoluble, low Tg (<−70° C.), semicrystalline polymer, similar to polymers formed from other cyclic allyl sulfides, 3-methylene-1,4-dithiepane and 3-methylene-1,5-dithiacyclooctane. Despite solubility challenges, proton NMR revealed subtle changes in the methylene protons between the cyclic BMDTO monomer (3.41) and the ring opened PBMDTO (3.23).

The rigorous conditions used to synthesize poly(BMDTO) were used to synthesize copolymers of BMDTO and a variety of vinyl monomers: styrene (S), butyl methacrylate (BMA), methyl methacrylate (MMA), methyl acrylate (MA), 2-vinyl-4,4-dimethyl azlactone (VDMA), and 2-vinyl pyridine (2VP)). Effective copolymerization was visualized by the collective presence of both repeat units, as well as the emergence of new proton environments related to the crossover from BMDTO to the respective comonomer.

Despite apparent differences in crossover frequency, the overall incorporation of BMDTO was fairly uniform across the monomers tested. This phenomenon is consistent with previously reported cyclic allyl sulfide copolymerizations and may suggest copolymerization kinetics at odds with traditional terminal models. In addition to the evidence of copolymerization found by proton NMR, a decrease in the glass transition temperature as a function of BMDTO incorporation was observed, which is expected as PBMDTO was found to have a Tg lower than the detection limit of our instrument (Tg<−70° C. However, copolymers formed from S, 2VP, and BMA predict the Tg of PBMDTO to be ˜−120° C., while MMA and VDMA predict the Tg to be ˜−65° C. and MA predicts the Tg of PBMDTO to be ˜−30° C. by the Fox equation. These stark differences in predicted Tg of PBMDTO based on the Tg depression observed in the copolymers likely highlights microstructural differences in the resultant copolymers stemming from reactivity differences and potential rearrangements during radical polymerization. While the glass transition was impacted by the incorporation of BMDTO as a drop-in additive, the effect on thermal degradation was found to be minimal in the additive loading range tested (0.7-13 mol % BMDTO).

A summary of copolymers of vinyl monomers and BMDTO is provided in Table 1, including polymer composition, polymer characterization, and reaction conditions.

TABLE 1

| | | | | Reaction | Reaction | Collection | Mn | Mw | DTGₘₐₓ | Tg |
|---|---|---|---|---|---|---|---|---|---|---|
| Ex. | Comonomer | f_{B}¹ | F_{B}² | time (hrs) | pressure | %³ | (kDa)⁴ | (kDa)⁴ | (° C.) | (° C.) |
| 1 | S | 0.499 | 0.619 | 96 | reduced⁵ | 25.9 | — | — | 260.6 | <−70 |
| 2 | S | 0.127 | 0.068 | 96 | reduced | 9.9 | 17.9 | 37.9 | 416.9 | 59.3 |
| 3 | S | 0.157 | 0.060 | 96 | N₂ backfill | 54.2 | 15.2 (13.8) | 32.1 (28.4) | 417.2 | 69 |
| 4 | S | 0.091 | 0.024 | 168 | N₂ backfill | 57.3 | 19 (17.2) | 37.3 (33.1) | 425.9 | 85.5 |
| 5 | S | 0.020 | 0.012 | 96 | reduced | 48.5 | — | — | 427.7 | — |
| 6 | S | 0.012 | 0.0004* | 168 | reduced | 66 | 66.4 | 117.9 | 375.5 | 105.5 |
| | | | | | (2 hrs) | | | | | |
| | | | | | then N₂ | | | | | |
| | | | | | backfill | | | | | |
| 7 | BMA | 0.125 | 0.067 | 72 | N₂ backfill | 37.6 | (25.3) | (48.5) | 372.4 | 17 |
| 8 | BMA | 0.074 | 0.019 | 96 | reduced | 49.3 | 19.4 | 46.7 | 392.6 | 27.7 |
| 9 | BMA | 0.015 | 0.001* | 144 | reduced | 68.7 | 47.1 | 91.8 | 392.8 | 35.4 |
| 10 | MMA | 0.121 | 0.078 | 72 | N₂ backfill | 55.9 | (15.5) | (41.8) | 364.8 | 82.6 |
| 11 | MMA | 0.114 | 0.076 | 72 | N₂ backfill | 48.8 | (16.2) | (39.5) | — | 86.3 |
| 12 | MMA | 0.166 | 0.066 | 96 | reduced | 59.7 | (24.6) | (54.5) | 389.5 | 82.8 |
| | | | | | (2 hrs) | | | | | |
| | | | | | then N₂ | | | | | |
| | | | | | backfill | | | | | |
| 13 | MMA | 0.090 | 0.031 | 96 | reduced | 62.6 | 22.4 (27.9) | 56.1 (52.2) | 401.4 | 94.2 |
| 14 | MMA | 0.013 | 0.008 | 144 | reduced | 31.9 | 77.5 (84.1) | 208.7 (205.3) | 393.5 | 117.6 |
| 15 | MA | 0.131 | 0.130 | 72 | N₂ backfill | 35.7 | (6.1) | (26.9) | 405.3 | 1.5 |
| 16 | MA | 0.084 | 0.083 | 72 | N₂ backfill | 35.7 | (9.43) | (38.1) | 410.6 | 5.6 |
| 17 | VDMA | 0.022 | 0.006 | 144 | reduced | 69.5 | 87.4 | 201.4 | 296.4 | 87.6 |
| 18 | 2VP | 0.021 | 0.007 | 96 | reduced | 78.1 | 100.5 | 216.8 | 416.8 | 98.8 |
| 19 | 2VP | 0.019 | 0.007 | 144 | reduced | 77.1 | 117.1 | 225.5 | 414.5 | 99 |
| | | | | | (2 hrs) | | | | | |
| | | | | | then N₂ | | | | | |
| | | | | | backfill | | | | | |

¹f_{B} = molar equivalence of BMDTO in reaction at t = 0;
²F_{B} = molar equivalence of BMDTO incorporated in copolymer product (as determined by ¹H NMR);
³Collection % = the weight of precipitate collected over the weight of monomer added (lowest possible estimate of conversion, as some product is lost in precipitation and handling);
⁴SEC results provided in parentheses indicate THF as the eluent, and results not in parentheses indicate DMF as the eluent;
asterisk (*) indicates samples with fewer than one BMDTO per chain and are polymer blends of homopolymer and copolymer;
⁵“reduced” means a pressure of about 100 Torr.

### Radical Scission

With the successful copolymerization of BMDTO and S, BMA, MMA, MA, and 2VP, the dynamic nature of the latent allyl sulfides present within the backbone was explored. The allyl sulfide groups are believed to remain radically reactive and can be exchanged with competing thiyl radicals. To favor chain scission and maximize the drop in molecular weight, an excess of competing thiol was added (e.g., 2.5 equivalence with respect to incorporated BMDTO) and the reaction was conducted at elevated temperatures (80° C.), as illustrated in FIG. 2. As drawn in FIG. 2, the proposed radical chain scission by thermal initiation in the presence of allyl dithiol results in a chain end which preserves the allyl sulfide—allyl thiol functionality. While the persistence of vinylic protons was robustly observed, there was an unexpected shift in the methylene environment (from 3.23 to 2.85 ppm). Additionally, the presence of a thiol end group was challenging to validate, however, the presence of thiol functionality was observed by FT-IR in the >5 μmol % BMDTO copolymers. The precise number of allyl sulfide units at the chain end remains uncertain because of the possibility of a distribution of allyl sulfide units, as well as crowded nature of the proton NMR surrounding thiol proton chemical shift range. Additionally, although the chemical structure of the radical scission product is drawn with one chain end represented explicitly as an allyl thiol, there is likely a higher number of telechelic chains with allyl thiol functionality at both chain ends.

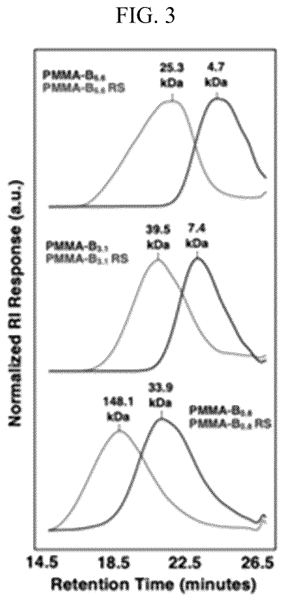

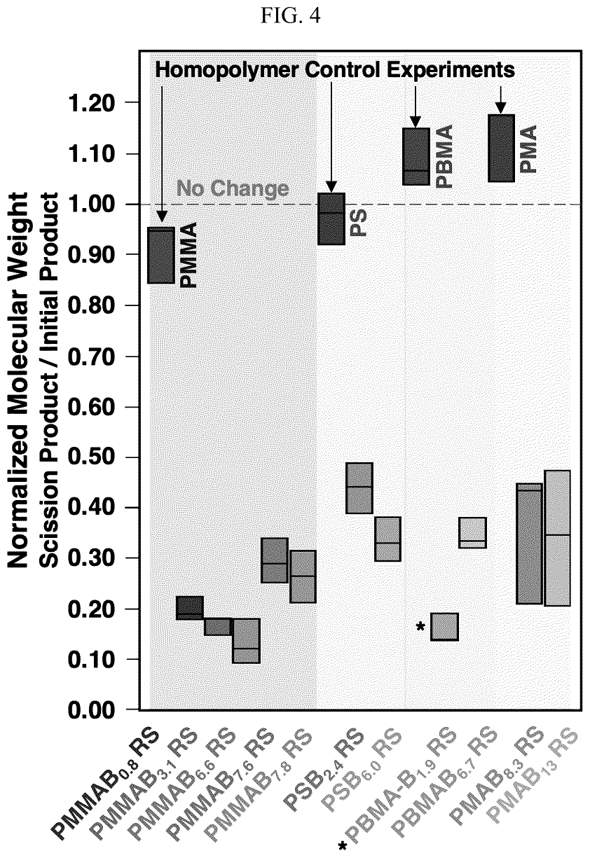

Despite uncertainty regarding the exact nature of the chain end formed, successful chain scission in PS-B, PBMA-B, PMMA-B, and PMA-B copolymers was found. Representative changes from initial copolymer to scission product molecular weight distributions are shown in the gel permeation chromatography traces in FIG. 3, where a complete shift to longer retention times in each case is observed, signifying a drop in the molecular weight; this is true even in the sample with 0.7 mol % BMDTO loading. A summary of all scission reactions is shown in FIG. 4, where the mass is normalized by the initial copolymer size. To account for any confounding thermal effects, homopolymers of styrene, butyl methacrylate, methyl methacrylate, and methyl acrylate were also exposed to the scission reaction condition temperatures in the presence of allyl dithiol. As expected, these control samples without BMDTO in the backbone did not result in a significant change in the GPC trace and the normalized mass stayed approximately one. Contrary to the molecular weight changes observed for PS-B, PBMA-B, PMMA-B, and PMA-B copolymers, P2VP-B samples demonstrated no change when they were subjected to radical scission conditions. While initially surprising, these results may be rationalized by considering competing acid-base interactions between the allyl thiol and the pyridine repeat units and subsequent suppression of thiyl radical formation. The proton NMR of the P2VP-B copolymers before and after radical scission indicate no chemical change, supporting acid/base suppression of radical cascade. These results may highlight a potential limit to the side group tolerance for the recycling scheme presented herein.

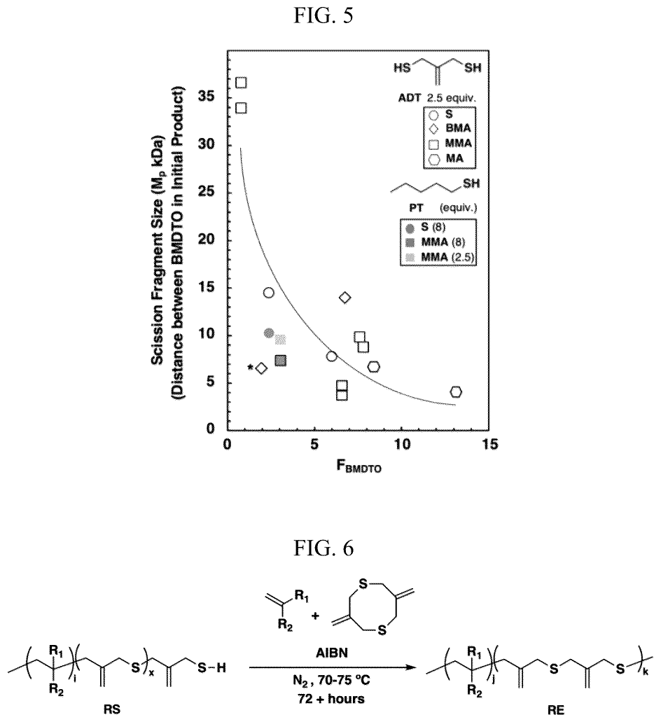

The resultant fragment size following radical chain scission appeared to be inversely related to the BMDTO incorporation in the initial copolymer, however, increasing BMDTO loading from 6 to 13 mol % did not result in substantial changes in the observed fragment size (Mp), as shown in FIG. 5. This observed exponential decay approaching some equilibrium fragment size may highlight the average distance between BMDTO units and the frequency of comonomer addition versus BMDTO addition in the initial growing copolymer. Remarkably, radical chain scission occurs readily and repeatably, where the same starting copolymers reliably produce fragments of a similar size, even when alternative thiol sources are used (see FIG. 5, open versus filled data points). In addition to producing similar size fragments in iterative, independent reactions and with different thiol sources, these experiments demonstrate invariability with increasing reaction scale (70-300 mg of starting copolymer. Although, pentane thiol (PT) successfully performed as a radical transfer agent, proton NMR revealed the elimination of BMDTO peaks. This finding suggests the consumption or elimination of allyl sulfide groups from polymer fragments during the scission reaction; without the allyl sulfide functionality at the chain ends, scission fragments formed from pentane thiol were inactivated.

A summary of the results of various radical chain scission reactions is provided in Table 2.

TABLE 2

| | F_{BMDTO} | M_{p, i} | M_{n, i} | M_{w, i} | Recovery | M_{p, RS} | M_{n, RS} | M_{w, RS} |
|---|---|---|---|---|---|---|---|---|
| Monomer | (mol %) | (kDa) | (kDa) | (kDa) | (%) | (kDa) | (kDa) | (kDa) |
| MMA | 0 | 1190 | 219 | 792 | 92 | 1010 | 306 | 755 |
| | 0.8 | 148.1 | 84.1 | 205.3 | 65 | 36.6 | 20.8 | 42.6 |
| | | | | | 58 | 33.9 | 16.5 | 38 |
| | 3 | 39.5 | 27.9 | 52.2 | 55 | 7.4 | 5.2 | 8 |
| | 6.6 | 25.3 | 24.6 | 54.5 | 62 | 4.8 | 3 | 5.1 |
| | | | | | 67 | 3.7 | 2.9 | 4.7 |
| | | | | | 71 | 4.7 | 3.1 | 5.5 |
| | 7.6 | 33.4 | 16.2 | 39.5 | 94 | 9.8 | 5.6 | 10.1 |
| | 7.8 | 32.7 | 15.5 | 41.8 | 88 | 8.8 | 5 | 9.1 |
| MA | 0 | 566 | 73.7 | 548 | 60 | 667 | 174 | 647 |
| | 8.3 | 15.1 | 9.4 | 38 | 97 | 6.8 | 4.1 | 8.2 |
| | 13 | 11.4 | 6.1 | 26.9 | 98 | 4 | 2.9 | 5.7 |
| BMA | 0 | 720 | 352 | 743 | 92 | 731 | 377 | 775 |
| | 1.9² | 45.8 | 19.4 | 46.7 | 65 | 6.5 | 3.8 | 6.5 |
| | 6.7 | 41.2 | 25.3 | 48.5 | 74 | 14 | 7.7 | 13 |
| S | 0 | 149.1 | 108.2 | 413 | 95 | 147.3 | 111.6 | 383 |
| | 2.4 | 29.4 | 17.2 | 33.1 | 60 | 14.5 | 7.7 | 13 |
| | 6 | 20.2 | 13.8 | 28.4 | 73 | 7.8 | 4.6 | 8.5 |
| 2VP¹ | 0.7 | 168.1 | 100.6 | 217 | 82 | 190.3 | 92.8 | 181.7 |
| | 0.7 | 183.5 | 117.1 | 226 | 84 | 236 | 135.2 | 233 |

¹conducted on the DMF SEC; all other data from THF SEC.
²bimodal trace observed.
‘I’ represents the initial product.
‘RS’ represents the product after exposure to scission reaction conditions.

### Radical Extension

With the perseverance of allyl sulfide functionality in fragments formed through radical scission with allyl dithiol as the thiol source, chain extension reactions were performed and mirrored the conditions used in the initial copolymerization of BMDTO and respective comonomer, as shown in FIG. 6. Similar to the copolymerization conditions, an evacuated vessel was used in the first extension attempts; however, it was found that a nitrogen atmosphere was sufficient to promote extension and prevented comonomer evaporation. The decision to replenish the BMDTO monomer additive concentration in the extension reaction was motivated by combating dilution effects. All reactions were carried out in bulk, except for the case of PBMA-B and PMA-B extension, in which anhydrous toluene was used to increase the concentration of scission fragments relative to extension monomers. Proton NMR of the chain extended products PS-B, PBMA-B, PMMA-B, and PMA-B were comparable to the initial copolymer.

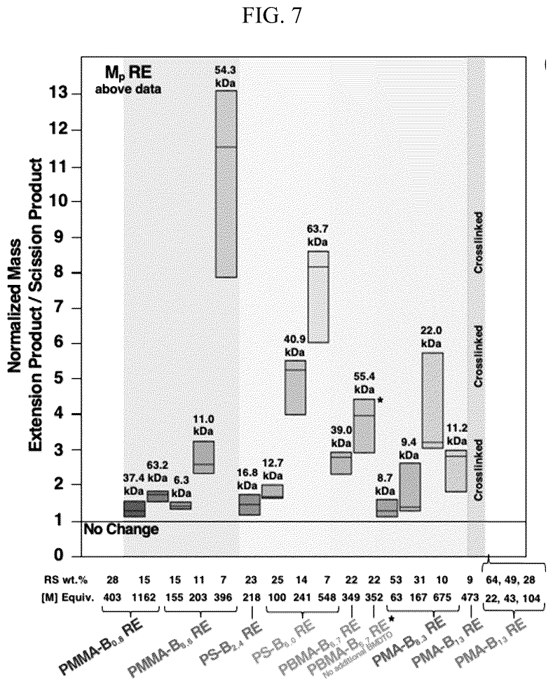

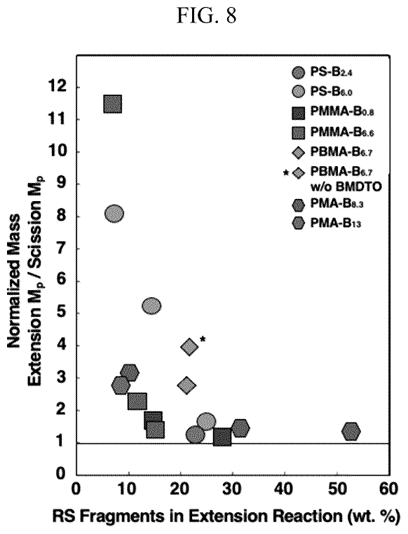

A summary of the molecular weight changes in all extension reactions performed is shown in FIG. 7, where the fragment identity, weight percentage of fragments present in the extension reaction, and the molar equivalence of vinyl comonomer are indicated. In general, we observe an increase in the extension when the molar equivalence of comonomer is increased with respect to the scission fragment. Conversely, when scission fragment concentration increases, the observed molecular weight change decreases (FIG. 8). Despite this, greater than 50% extension was observed in PS-B, PMA-B, and PBMA-B RS samples where the scission fragments were between 20-30 wt. %. While this data taken together, insinuates fragment-fragment addition does not occur, when PMA-B13 RS concentrations were above 9 wt. % in an extension reaction, unexpected crosslinked products (MW→∞) were observed, suggesting the possibility of fragment-fragment addition and/or crosslinking through side reactions (potentially thiol-ene like) with residual allyl dithiol. This was the only sample which crosslinked.

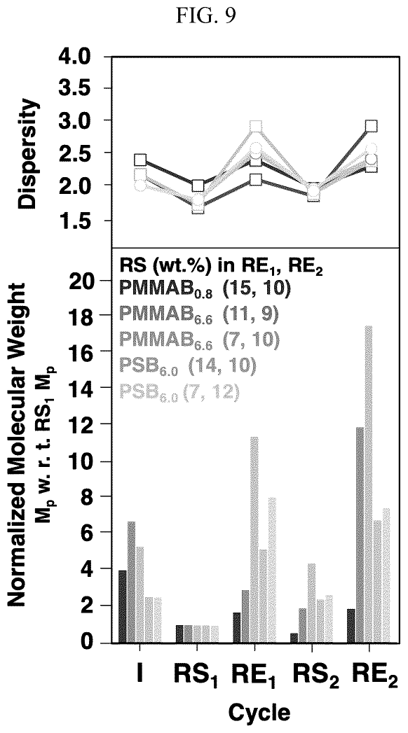

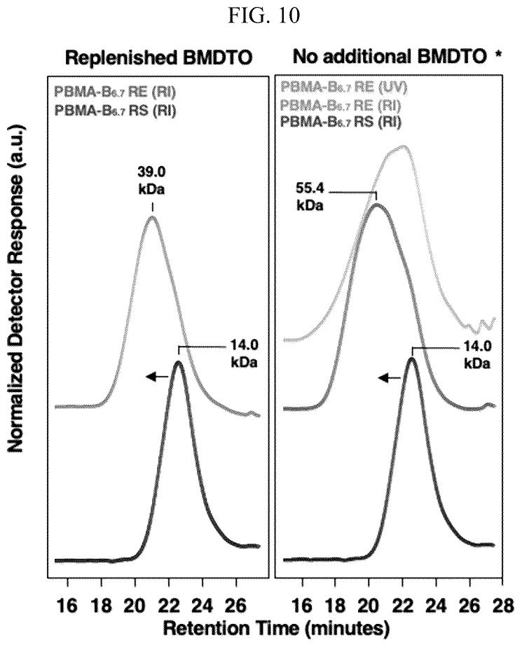

PMMA-B and PS-B samples were successfully taken through two consecutive scission-extension cycles (FIG. 9). Importantly, large deviations in dispersity from the expected ˜2.5-3.0 for free-radical processes with MMA and S were not observed. To investigate extension off of scission fragments, versus the formation of any potential polymer in the extension reaction media, the extension of PBMA-B RS with the replenishment of BMDTO and without the replenishment of BMDTO were compared (FIG. 10). Similar extension in both the reaction with additional BMDTO (Mp˜39.0 kDa) and the reaction without BMDTO (Mp˜55.4 kDa) was observed. Importantly, the sample without additional BMDTO allowed use of dual detection GPC, in order to visualize where the allyl sulfide containing chains (scission fragments) were distributed, as BMDTO is UVB active and BMA is UVB transparent (hv=280 nm. Even the chains with the shortest retention time (i.e., highest MW) are UV active and contain allyl sulfide functionality. This indicates that all chains likely originated from scission fragments and confers successful chain extension. The intensity shift in the UV trace is skewed toward the longer retention times (shorter molecular weights), and this is likely due to a concentration gradient where the chains which have extended the most have diluted the UVB active BMDTO and appear weaker in comparison to the chains which have lower degrees of extension.

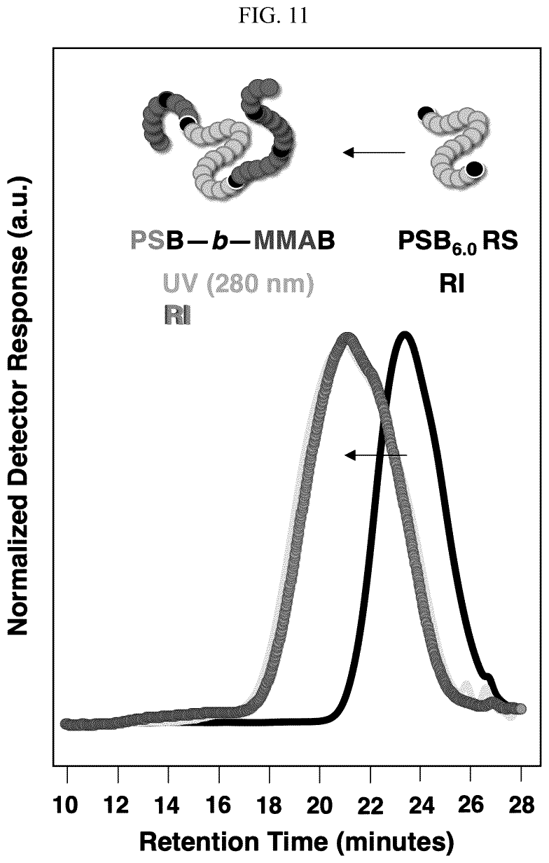

Similar in concept to chain extension to reform higher molecular weight polymers, block copolymers were prepared by performing chain extension of a dissimilar monomer off of a scission fragment (FIG. 11). The successful extension of PS-B fragments with MMA and BMDTO was demonstrated, visualized by the shift in the retention time of the GPC trace and confirmed by proton NMR where we observe the coexistence of S peaks, MMA peaks, and crossover peaks (PS-B PMMA-B). Additionally, an acetonitrile extraction on the crude material synthesized in PS-B extension with MMA and BMDTO confirmed both the reality of media formed polymer excluding scission fragments, PMMA-B (soluble in room temperature acetonitrile), and the successful synthesis of intended block copolymer, PS-B-b-PMMA-B (insoluble in room temperature acetonitrile, represents 34% by weight of crude material). Agreement between the RI and UVB (hv=280 nm) GPC traces for this sample was observed, which indicates homogeneous composition throughout the molecular weight distribution with respect to both BMDTO and styrene concentrations.

A summary of radical chain extension reaction conditions and results is provided in Table 3.

TABLE 3

| RS | F_{BMDTO} | M_{p, RS} | M_{n, RS} | M_{w, RS} | RS | Monomer | BMDTO | | | M_{p, RE} | M_{n, RE} | M_{w, RE} |
|---|---|---|---|---|---|---|---|---|---|---|---|---|
| product | (mol %) | (kDa) | (kDa) | (kDa) | (mg) | (mg) | (mg) | Solvent | Pressure | (kDa) | (kDa) | (kDa) |
| MMA | 0.8 | 33.9 | 16.5 | 38 | 68 | 167 | 8 | (bulk) | reduced¹ | 37.4 | 25.4 | 48.3 |
| | | 36.6 | 20.8 | 42.6 | 43 | 241 | 10 | (bulk) | atmospheric | 63.2 | 31.9 | 77.5 |
| | 6.6 | 4.8 | 3 | 5.1 | 30 | 160 | 12 | (bulk) | reduced | 6.3 | 4.2 | 7.7 |
| | | | | | 82 | 572 | 61 | (bulk) | atmospheric | 11 | 7.7 | 16.5 |
| | | 4.7 | 3.1 | 5.5 | 78 | 999 | 57 | (bulk) | atmospheric | 54.3 | 24.6 | 72.3 |
| MA | 8.3 | 6.8 | 4.1 | 8.2 | 25 | 217 | 7 | THF | atmospheric | 22 | 12.6 | 47 |
| | | | | | 52 | 109 | 4 | THF | atmospheric | 9.4 | 5.2 | 21.6 |
| | | | | | 104 | 83 | 9 | THF | atmospheric | 8.7 | 3.6 | 13 |
| | 13 | 4 | 2.9 | 5.7 | 24 | 248 | 7 | THF | atmospheric | 11.2 | 5.2 | 16.9 |
| | | | | | 34 | 78 | 7 | THF | atmospheric | Crosslinked | | |
| | | | | | 79 | 75 | 7 | THF | atmospheric | | | |
| | | | | | 107 | 51 | 8 | THF | atmospheric | | | |
| BMA | 6.7 | 14 | 9.8 | 15.8 | 68 | 242 | 7 | THF | atmospheric | 39 | 22.5 | 46.2 |
| | | | | | 92 | 329 | 0 | THF | atmospheric | 55.4 | 28.4 | 69.8 |
| S | 2.4 | 14.5 | 7.7 | 13 | 52 | 155 | 20 | (bulk) | atmospheric | 16.8 | 11.1 | 22.5 |
| | 6 | 7.8 | 4.6 | 8.5 | 69 | 157 | 36 | (bulk) | atmospheric | 12.7 | 7.7 | 17 |
| | | | | | 85 | 465 | 39 | (bulk) | atmospheric | 40.9 | 18.5 | 46.9 |
| | | | | | 75 | 931 | 73 | (bulk) | atmospheric | 63.7 | 27.9 | 73.2 |

Molecular weights obtained using GPC with THF as eluent.
¹“reduced” means a pressure of about 100 Torr.

Accordingly, a new synthetic approach to form 8-membered CAS, 3,7-bismethylene-1,5-dithiacyclooctane (BMDTO) and the effective incorporation of this versatile comonomer additive with a variety of common vinyl monomers (styrene, methyl methacrylate, butyl methacrylate, methyl acrylate, 2-vinyl pyridine, and 2-vinyl-4,4-dimethyl azlactone) has been demonstrated. BMDTO radically ring opens and imparts its continued proclivity for radical rearrangements following copolymerization, as demonstrated by rapid, systematic radical chain scission in the presence of thiols. Importantly, the fragments formed retain their radical reactivity and can nucleate the formation of new polymer chains as a macromolecular chain-transfer agent and as such is unlimited in the pursuit of a desired molecular weight recycled product. Successful cyclability and the ability to upcycle fragments through extension with other monomer types to form block copolymers attractive for uses outside of commodity plastics has also been demonstrated. Thus a significant improvement is provided by the present disclosure.

As discussed above, BMDTO has been identified as an attractive comonomer additive for producing chemically recyclable vinyl-derived polymers, due to its ability to copolymerize with a variety of vinyl monomers, minimally impact thermal properties, and foster scission and extension for closed-loop recycling. Copolymerization was also observed to exhibit a reduced rate of polymerization and a decrease in copolymer molar mass. Both the apparent decrease in the rate of polymerization and the decrease in molar mass with BMDTO content can be rationalized by considering transfer during copolymerization. Main chain allyl sulfides are susceptible to radical exchange, which occurs simultaneously with radical copolymerization effectively slowing the rate of polymerization and reducing molar mass, as established chains may be exchanged with smaller newly formed chains. This unintended addition-fragmentation-transfer (AFT) during copolymerization is referred to as undesired transfer.

The present inventors have found that synthesis of allyl sulfide containing copolymers by particular methods using radical control and isolation can limit undesirable transfer during cyclic allyl sulfide copolymerization to produce high molar mass copolymers.

BMDTO Compatibility with Controlled Techniques

In order to test whether undesired transfer of allyl sulfide repeat units could be curtailed by the addition of a radical mediator reducing the concentration of propagating radicals during copolymerization, controlled radical copolymerization of methyl methacrylate and BMDTO was conducted using ATRP and RAFT. To evaluate potential confounding effects from transfer to solvent, solvated free radical copolymerization of methyl methacrylate and BMDTO was conducted with the same concentration and solvent conditions used in later ATRP and RAFT reactions. Polymer synthesis was conducted according to the below methods.

### Solvated Free Radical Copolymerization

A dry glass tube equipped with a magnetic stir bar was charged with MMA (0.521 g, 5.2 mmol, 950 equiv.), BMDTO (90 mg, 0.52 mmol, 95 equiv.), purified AIBN (0.9 mg, 0.005 μmmol, 1 equiv.), and anhydrous toluene (˜0.6 mL). Reaction solution was taken through 4 cycles of freeze-pump-thaw and placed under nitrogen. The reaction solution was then heated to 70° C. After 70 hours, the reaction viscosity increased and the reaction was cooled to room temperature and diluted in dichloromethane. The reaction mixture was added dropwise to hexanes. Polymer was collected and dried under vacuum. Polymer mass recovered after precipitation˜68% yield.

### Atom Transfer Radical Polymerization

A dry glass tube equipped with a magnetic stir bar was charged with MMA (0.461 g, 4.60 mmol, 100 equiv.), BMDTO (83 mg, 0.48 mmol, 10.4 equiv.), tris[2-dimethylamino]ethylamine (Me6TREN) (23 mg, 0.10 mmol, 2.2 equiv.), and anhydrous toluene (˜0.8 mL). Monomer-ligand solution was taken through 5 cycles of freeze-pump-thaw and placed under nitrogen. Another dry reaction vessel is equipped with a magnetic stir bar is charged with ethylene bis(2-bromo-isobutyrate) (9.20 mg, 0.03 mmol, 0.65 equiv.) and purified copper bromide (7.02 mg, 0.05 μmmol, 1.1 equiv.). The copper flask was then taken through three evacuation/N2 charge cycles while in a liquid N2 bath, and placed under nitrogen. The monomer-ligand solution was cannulated into the copper flask and the reaction flask was then taken through 6 cycles of freeze-pump-thaw and placed under nitrogen. The reaction solution was allowed to stir at room temperature for 30 minutes and then taken to the reaction temperature 70° C. over the course of 20 minutes. After 70 hours, the reaction viscosity increased and the reaction was cooled to room temperature and diluted in dichloromethane. The reaction mixture was passed through a short basic alumina column (prewet with dichloromethane) and added dropwise to hexanes. Polymer was collected and dried under vacuum. Polymer mass recovered after precipitation˜39% yield.

### Reversible Addition Fragmentation Transfer Copolymerization

A dry glass tube equipped with a magnetic stir bar was charged with MMA (0.521 g, 5.20 mmol, 950 equiv.), BMDTO (90 mg, 0.52 mmol, 95 equiv.), 4-cyano-4-thiobenzoylthiopentanoic acid (3.7 mg, 0.013 mmol, 2.5 equiv.), purified AIBN (1 mg, 0.006 mmol, 1 equiv.), and anhydrous toluene (˜0.6 mL). Reaction solution was taken through 3 cycles of freeze-pump-thaw and placed under nitrogen. The reaction solution was then heated to 70° C. After 70 hours, the reaction viscosity increased and the reaction was cooled to room temperature and diluted in dichloromethane. The reaction mixture was added dropwise to hexanes. Polymer was collected and dried under vacuum. Polymer mass recovered after precipitation˜70% yield.

As all previous copolymerizations with BMDTO were conducted under bulk free radical conditions solvated free radical copolymerization was conducted to determine the potential role solvent effects would have on BMDTO content and copolymer molar mass. Solvated free radical copolymerization resulted in copolymers by ¹H NMR with comparable copolymerization behavior to bulk. Further, the molar mass of solvated free radical copolymers fell within the anticipated range consistent with bulk, suggesting transfer to solvent is minor compared to the undesired transfer of allyl sulfide repeat units. Dispersity in solvated FRP copolymers also matched expectations from bulk FRP, where dispersity ranged from 2.0 to 3.0.

Copolymerization was also assessed by performing radical scission with allyl dithiol consistent with previously developed methods. If there are main chain allyl sulfides in the copolymer, i.e. if copolymerization is successful, the entire molar mass distribution should shift to higher retention times, indicating radical scission is preserved. The solvated FRP products undergo radical scission demonstrating the successful copolymerization of methyl methacrylate and BMDTO when dissolved in anhydrous toluene. Further, the normalized mass of the scission products relative to the initial copolymers is comparable between bulk and solvated FRP samples, which indicates similar scission performance between these copolymers.

Atom transfer radical copolymerization of methyl methacrylate and BMDTO was conducted following an established procedure for the homopolymerization of MMA where ethylene bis(2-bromoisobutyrate), 2f-BiB, acts as a difunctional initiator. Following copper removal and precipitation, a copolymer product is isolated which contains both MMA and BMDTO repeat units consistent with previous copolymer FRP spectra. The anticipated central ethylene environment alpha to the ester of 2f-BiB is visible in the copolymer product, supporting the telechelic structure. Further, agreement between the number average molar mass calculated by ¹H NMR (FBMDTO˜7.23%; Mn˜8 kDa) and estimated by SEC (FBMDTO˜7.23%; Mn˜11.6 kDa) supports the structure.

Similarly, an established procedure for reversible addition fragmentation transfer polymerization is followed for the RAFT copolymerization of MMA and BMDTO. Precipitation and isolation revealed a copolymer with both MMA and BMDTO repeat units consistent with all previous copolymer spectra. The acrylate chain transfer agent (CTA), 4-cyano-4-thiobenzoylthiopentanoic acid, is visible by ¹H NMR and the copolymer has the stereotypical pink pigment of RAFT polymers, suggesting the retention of the CTA end group. Agreement between the number average molar mass by ¹H NMR (FBMDTO˜4.91%; Mn˜7 kDa) and that observed by SEC (FBMDTO˜4.91%; Mn˜8.1 kDa) suggests that copolymerization can result in copolymers with high retention of CTA on the chain end.

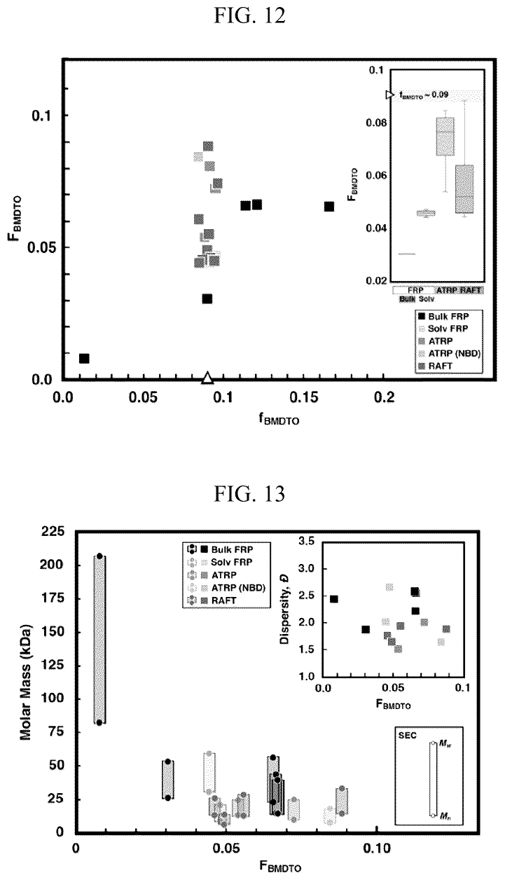

Given the successful synthesis of allyl sulfide containing copolymers by both ATRP and RAFT, BMDTO copolymerization behavior and the resultant molar mass achieved under these conditions was examined. Both ATRP and RAFT PMMAB copolymers have elevated BMDTO content compared to copolymers formed under free radical conditions, as shown in FIG. 12.

In particular, BMDTO content nearly doubled between solvated free radical and ATRP copolymerization with comparable MMA to BMDTO monomer ratios. Despite the success of BMDTO copolymerization observed in controlled polymerizations, the molar mass of the copolymers remained low, as shown in FIG. 13.

These results are rationalized by considering that the thiyl radical propagating species responsible for undesired transfer may be unaffected by the radical mediators present, leading to a polymerization with partial control during periods where a carbon-centered radical is present on the chain terminus. Over the course of the polymerization, the selective nature of the radical mediation is expected to favor the uncontrolled monomer, leading to elevated BMDTO copolymerization. Partial control in the ATRP and RAFT products is also supported by raised copolymer dispersity, which while marginally improved from FRP, were all higher than anticipated.

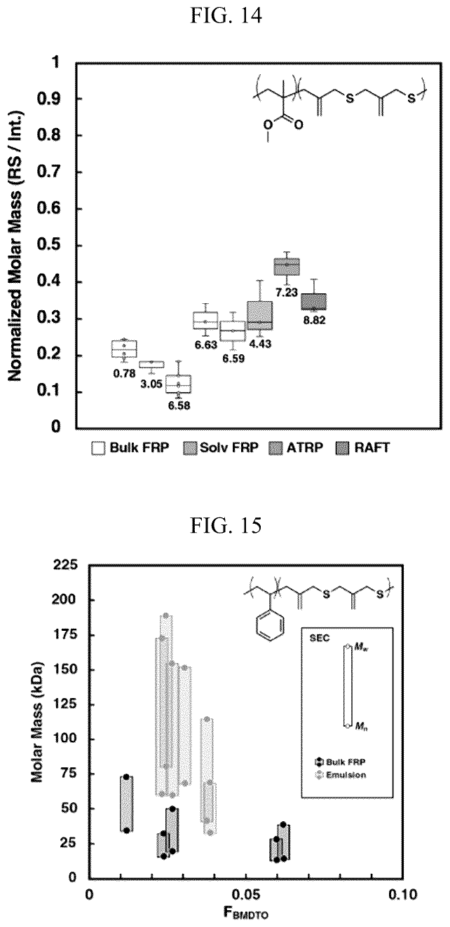

The retention of AFT activity was assessed in copolymers by conducting radical scission reactions with allyl dithiol. Both ATRP and RAFT BMDTO copolymers underwent scission, and the product distributions shifted to longer retention times by SEC. Further, the normalized mass of scission products relative to initial is comparable between FRP, ATRP, and RAFT, indicating similar scission performance between these copolymers (FIG. 14).

The preservation of radical scission highlights not only the fact that these products contain main chain allyl sulfides, but corroborates that the mediating end groups are unsuccessful in suppressing thiyl radical activity similar to that of undesired transfer.

Limiting Transfer of Allyl Sulfides through Radical Compartmentalization

Emulsion polymerization relies on radical compartmentalization to keep local radical concentrations low. This strategy may be advantageous for suppressing unwanted AFT during BMDTO copolymerization by physically isolating propagating chains from one another and reducing the number of interactions between a thiyl radical and an established chain. Emulsion copolymerizations between vinyl monomers and cyclic allyl sulfides were conducted by copolymerizing styrene and BMDTO, and methyl methacrylate and BMDTO. These reactions are assessed based on the copolymerization behavior of BMDTO, resultant molar mass, and ability of copolymer products to undergo radical scission. Polymerization procedures are described below.

### Emulsion Copolymerization

A dry glass tube equipped with a magnetic stir bar was charged with styrene (1.880 g, 18.06 mmol, 100 equiv.), BMDTO (110 mg, 0.64 mmol, 3.5 equiv.), polyethylene glycol (˜250 mg), sodium dodecyl sulfate (˜100 mg), and deionized water (˜3 mL). The reaction mixture was vortexed for two minutes and sonicated in a bath sonicator for 5 μminutes. The solution should be a bright white indicating an emulsion has formed. The reaction is then vigorously stirred and purged with nitrogen for 10 minutes prior to being sealed and heated to 75° C. After 15 μminutes at temperature, an initiator solution is added such that the reaction flask is charged with potassium persulfate (12 mg, 0.04 mmol, 0.2 equiv.) and deionized water (0.4 mL). The reaction is allowed to stir at 75° C. for 70 hours. Following reaction, the emulsion is cooled to room temperature and methanol is added. The methanol mixes with the water and product falls to the bottom of the reaction vessel by gravity. The methanol/water is removed and more methanol is added. This process is repeated three times before the product at the bottom is dried. Once dry, the product is dissolved into chloroform, and precipitated into 40-45° C. methanol. The product is “hot” precipitated twice to remove emulsifying agents. Polymer was collected and dried under vacuum. Polymer mass recovered after precipitation˜50% yield.

All reactions yielded polymer products with both styrene and BMDTO repeat units by ¹H NMR, and match spectra of previously synthesized PSB copolymers. Copolymerization under emulsion conditions resulted in marginally elevated BMDTO content in the resultant copolymers compared to bulk. Product dispersity remained consistent with bulk FRP samples, ranging from 2.0 to 3.0, with no apparent trend with BMDTO content. A substantial increase in molar mass was observed in copolymers formed by emulsion polymerization, as shown in FIG. 15.

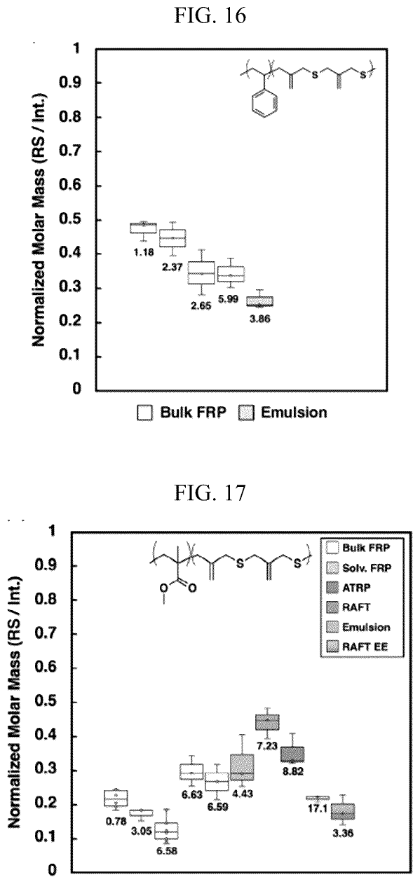

Radical scission with allyl dithiol was performed. Emulsion PSB copolymers readily undergo radical scission, as visualized by a clear shift in the distribution toward longer retention times indicating the cleavage of main chain allyl sulfides through AFT. Supplemental support of preserved AFT activity in emulsion copolymers is also seen in FIG. 16 where the normalized mass of scission products relative to initial copolymer remains comparable, indicating similar scission performance.

Due to emulsion instabilities observed, a two-step polymerization involving the extension of RAFT PMMAB copolymers under emulsion conditions was investigated. This approach aims to stabilize monomer micelles by adding dissolving RAFT macromolecular CTA copolymers within them which undergo chain extension to produce high molar mass BMDTO copolymers.

Emulsion extension of RAFT PMMAB copolymer macromolecular chain transfer agent (macroCTA) uses homogeneous solution of monomer(s) and the dithiobenzoate functionalized macroCTA is formed prior to emulsion generation. Empirically, emulsion stability greatly improved under these conditions, and these reactions yielded polymer products with faint pink pigment. MacroCTA extension is inferred from ¹H NMR where an apparent decrease in BMDTO is observed consistent with an averaging between the monomer ratio during RAFT copolymerization and during emulsion extension. This finding is strengthened by SEC where the product shifts to shorter retention time, indicating an increase in molar mass. Emulsion extension PMMAB copolymer molar mass increases above all previously synthesized samples with comparable BMDTO content, suggesting emulsion extension of macroCTAs is a viable method for limiting undesired transfer and synthesizing high molar mass copolymers from cyclic allyl sulfides and vinyl monomers. An exemplary polymerization procedure is provided below.

### Emulsion Extension Copolymerization

A dry glass tube equipped with a magnetic stir bar was charged with RAFT PMMAB copolymer (˜100 mg, ˜0.01 mmol, ˜0.11 equiv.), BMDTO (71 mg, 0.41 mmol, 4.5 equiv.), and MMA (0.920 g, 9.19 mmol, 100 equiv.). The macromolecular CTA (PMMAB) was fully dissolved after 30 minutes and the reaction vessel was charged with polyethylene glycol (˜80 mg), sodium dodecyl sulfate (˜100 mg), and deionized water (˜3 mL). The reaction mixture was vortexed for two minutes and sonicated in a bath sonicator for 5 μminutes. The solution should be a bright white indicating an emulsion has formed. The reaction is then vigorously stirred and purged with nitrogen for 10 minutes prior to being sealed and heated to 75° C. After 15 μminutes at temperature, an initiator solution is added such that the reaction flask is charged with potassium persulfate (6.4 mg, 0.02 mmol, 0.2 equiv.) and deionized water (0.4 mL). The reaction is allowed to stir at 75° C. for 70 hours. Following reaction, the emulsion is cooled to room temperature and methanol is added. The methanol mixes with the water and product falls to the bottom of the reaction vessel by gravity. The methanol/water is removed and more methanol is added. This process is repeated three times before the product at the bottom is dried. Once dry, the product is dissolved into chloroform, and precipitated into room temperature hexanes. Polymer was collected and dried under vacuum. Polymer mass recovered after precipitation˜50% yield.

Radical scission with allyl dithiol was performed to confirm both the presence of main chain allyl sulfides and the ability for emulsion extension products to undergo AFT. Radical scission elicited a corresponding shift in the product SEC toward longer retention times indicating the existence of main chain allyl sulfides and their preserved proclivity to radical exchange by AFT. Accompanying support of continued AFT reactivity in emulsion extension copolymers is also seen in FIG. 17 where the normalized mass of scission products relative to initial copolymer remains tantamount to previously synthesized copolymers, indicating uncompromised scission performance in high molar mass copolymers.

Ultrasonic welding (USW) is a popular fusion bonding technique for thermoplastics commonly used in industry, which employs high frequency (˜20-40 kHz) mechanical vibration to locally generate heat and join materials within seconds. Like other techniques, USW relies on material thermal transitions to impart mobility and allow for interdiffusion across an interface. Mechanical reinforcement of the interface is achieved by the formation of a diffuse interfacial domain and can be further stabilized by entanglements. Polymer immiscibility poses a substantial hurdle in applying these techniques to mixed polymer welds, as phase separation and limited interdiffusion leads to a thin, and in turn mechanically weak, interface. As a topic attracting interdisciplinary research over many decades, the interfacial properties of immiscible polymer blends can be improved by adding additional components as compatibilizers, either functionalized nanoparticles, block copolymers, or interposed sheets. The present inventors sought to achieve ultrasonic welding between immiscible polymers through block copolymer compatibilizer generation by dynamic bond exchange at the joining interface.

The development of self-initiated AFT in allyl sulfide containing copolymers for enhanced adhesion between immiscible polymers by ultrasonic welding is reported. AFT self-initiation occurs by dithiobenzoate end-group thermolysis and subsequent generation of polymeric radical species capable of exchange with main chain allyl sulfide repeat units. End-group thermolysis under self-exchange conditions revealed suppression of depropagation and unexpected molar mass homogenization rationalized by a strengthening of the statistical average of the distribution through self-exchange. Consistent with conclusions drawn in self-initiated AFT under self-exchange conditions, end-group thermolysis in the presence of another copolymer type resulted in radical switch reactions leading to the formation of block copolymers simply on heating. This technology was then assessed for its compatibility with ultrasonic welding, whereby interfacial self-initiated sonoAFT forms block copolymer compatibilizers in-situ. Unlike ultrasonic welds between PMMA and PS homopolymers, welds between dithiobenzoate-capped PMMAB and PSB were strong, matching the normalized peel force of PS-PS self-welds in hanging weight peel experiments. Realization of confounding effects in peel experiments, motivated weld assessment by double cantilever beam testing, which revealed enhanced adhesion between dithiobenzoate-capped PMMAB and PSB relative to both PMMA-PS mixed welds and PS-PS self-welds. These preliminary findings highlight the significance of discovering AFT self-initiation, the potential of AFT chemistry in adhesion and ultrasonic welding, and the future of AFT in mixed-polymer compatibilization.

FRP, RAFT, and emulsion polymer samples were prepared as described previously. Polymer used are summarized in Table 4, which shows BMDTO copolymer content determined by ¹H NMR, and molar mass characteristics as determined by either DMF or THF SEC. Further, the experiment that each polymer products was involved in is included in the final column of Table 4 where ‘usw’ indicates the sample was used in either peel or double cantilever beam testing, ‘rs’ indicates the sample was used in either externally-initiated or self-initiated radical switch experiments, and ‘h’ indicates the sample was used in either externally-initiated or self-initiated homogenization AFT self-exchange experiments.

TABLE 4

| | | F (%) | | | | | |
|---|---|---|---|---|---|---|---|
| Polymer | | BMDTO | Mp | Mₙ | M_{w} | Ð | Exp |
| FRP | PS | 0 | 149.1 | 108.8 | 413.5 | 3.80 | usw |
| FRP | PMMA | 0 | 459.1 | 242.3 | 599.6 | 2.47 | usw |
| RAFT | PMMA | 0 | 47.9 | 28.9 | 39.8 | 1.37 | usw |
| FRP | PSB | 6.75 | 21.7 | 15.1 | 39.2 | 2.59 | rs |
| Emulsion | PSB | 2.98 | — | — | — | — | rs |
| Emulsion | PSB | 2.66 | 142.4 | 59.9 | 154.0 | 2.57 | usw |
| Emulsion | PSB | 3.05 | 133.9 | 68.6 | 151.3 | 2.20 | usw |
| Sol FRP | PMMAB | 4.74 | 18.8 | 8.1 | 21.6 | 2.67 | rs |
| Sol FRP | PMMAB | 4.43 | 57.8 | 30.4 | 60.6 | 1.99 | h |
| RAFT | PMMAB | 4.44 | 6.9 | 3.1 | 5.9 | 1.90 | h/rs |
| ‘blend’ | | | | | | | |
| RAFT | PMMAB | 5.53 | 18.6 | 10.0 | 19.4 | 1.94 | h/rs |
| Emulsion | PMMAB | 4.28 | 137.7 | 30.3 | 119.2 | 3.94 | h/rs |
| Ext | | | | | | | |
| Emulsion | PMMAB | 3.40 | 154.0 | 48.2 | 149.9 | 3.11 | usw |
| Ext | | | | | | | |

### Homogenization by AFT Self-Exchange

Externally Initiated Self Exchange: A dry glass tube equipped with a magnetic stir bar was charged with Sol FRP PMMAB4.43 copolymer (36 mg), AIBN (˜0.8 mg), and anhydrous dimethylformamide (0.4 mL). The reaction solution was stirred to dissolve the copolymer, and the solution was taken through 3 freeze-pump-thaw cycles and back filled with nitrogen. The reaction was then sealed, heated to 75° C., and allowed to stir for 8 hours. The reaction was cooled and precipitated into methanol. The product was collected and dried overnight by vacuum.

Self-Initiated (Dithiobenzoate Thermolysis) Self Exchange: A dry glass tube equipped with a magnetic stir bar was charged with either RAFT or EE PMMAB copolymers (˜50 mg), and anhydrous dimethylformamide (0.5 μmL). The reaction solution was stirred to dissolve the copolymer, and an initial aliquot is taken for ¹H NMR. The solution was then taken through 3 freeze-pump-thaw cycles and back filled with nitrogen. After deoxygenation, the reaction was then sealed, heated to 120° C., and allowed to stir for 3.5-8 hours. The reaction was cooled, and a final aliquot was taken for ¹H NMR. The rest of the reaction was precipitated into methanol. The product was collected and dried overnight by vacuum. Thermolysis of dithiobenzoate groups resulted in the reaction solution transitioning from a pink color to colorless. Further, unlike the starting PMMAB copolymers, the final polymer products did not have pink pigmentation. The retention of allyl sulfide functional groups after dithiobenzoate thermolysis was observed by ¹H NMR.

End group thermolysis under self-exchange conditions suggested AFT initiation by the suppression of depolymerization and the homogenization of the copolymer molar mass distribution. End group thermolysis in the presence of another copolymer further substantiated our discovery of self-initiated AFT by the creation of block copolymers by radical exchange between the two polymer types. Collectively, self-exchange and radical switch experiments verify that AFT is successfully self-initiated by dithiobenzoate cleavage on heating.

Externally-initiated AFT demonstrated a similar reduction in copolymer dispersity as was observed in self-initiated RAFT samples, where dispersity transitioned from 1.99 to 1.42 after allyl sulfide exchange. The narrowing in dispersity observed in the externally initiated positive control sample, supports the interpretation of homogenization by self-initiated AFT under self-exchange conditions.

To summarize, AFT self-exchange by dithiobenzoate end group thermolysis is supported by both the suppression of depolymerization and the homogenization of the molar mass distribution after heating. Narrowing of copolymer dispersity by allyl sulfide exchange is an unprecedented finding, which motivated the positive control experiment externally initiating AFT in PMMAB copolymers without dithiobenzoate ends. Similar to the homogenization observed by self-initiated AFT self-exchange, externally initiated AFT resulted in a narrowing of dispersity. While these results imply AFT is effectively self-initiated by dithiobenzoate end group thermolysis, further evidence is seen by chemical transformation through the exchange with another allyl sulfide containing copolymer, referred to as a radical switch reaction.

### Block Copolymer Synthesis by AFT Radical Switching

In this work, radical switch reactions refer to allyl sulfide exchange between two types of copolymers resulting in a block copolymer containing segments of both initial copolymers. As these reactions produce chemically distinct products, careful selection of the two initial copolymers can allow for isolation of block copolymers from unexchanged products through selective solvent extraction. Prior to testing self-initiation, an externally initiated radical switch reaction between PMMAB and PSB free radical copolymers was conducted.

Externally Initiated: A dry glass tube equipped with a magnetic stir bar was charged with Sol FRP PMMAB4.74 copolymer (57 mg), FRP PSB6.75 (51 mg), AIBN (1.2 mg), and anhydrous toluene (0.5 μmL). The reaction solution was stirred to dissolve both copolymers, and the solution was taken through 3 freeze-pump-thaw cycles and back filled with nitrogen. The reaction was then heated to 80° C. and allowed to stir for 4.5 hours. The reaction is then precipitated into room temperature hexanes, and the product is separated and allowed to stir in 40° C. acetonitrile for 12 hours. The acetonitrile soluble fraction was removed and the insoluble product was then stirred in 45° C. cyclohexane for 18 hours. The cyclohexane soluble fraction was removed and the insoluble product was isolated. All products are dried overnight by vacuum.

Selective solvent extraction revealed the resultant product contained minor unexchanged PMMAB and PSB, and a majority of new PMMAB-PSB block copolymer that was insoluble to both acetonitrile and cyclohexane. Supplementary to solubility, ¹H NMR confirmed the formation of block copolymer product by the coexistence of the aromatic environments of styrene and the methyl ester environment of MMA, while also showing the retention of allyl sulfide functionality.

In a manner consistent with externally initiated AFT, self-initiated radical switch reactions were conducted in samples containing dithiobenzoate end groups. Similarly, selective solvent extraction of the product revealed the presence of three fractions: unexchanged PMMAB, unexchanged PSB, and the formation of a new block copolymer PMMAB-PSB insoluble to acetonitrile and cyclohexane. Block copolymer structures were further corroborated by ¹H NMR where insoluble products contained styrene (43.2 mol %), MMA (52.2 mol %), and allyl sulfide repeat units (4.6 mol %). Self-initiated radical switch reactions all resulted in insoluble block copolymer products across the three types of dithiobenzoate containing samples tested: blend of RAFT PMMA and RAFT PMMAB, RAFT PMMAB, and emulsion extension (EE) RAFT PMMAB. It should be noted that the acetonitrile soluble fraction from self-initiated radical switch with RAFT PMMAB was cloudy and contained block copolymer by ¹H NMR, meaning the true mass of the acetonitrile soluble fraction is lower and the insoluble fraction higher than reported.

Self-Initiated (RAFT): A dry glass tube equipped with a magnetic stir bar was charged with RAFT PMMAB copolymer (˜50 mg), FRP PSB6.75 (˜50 mg), and anhydrous dimethylformamide (1.0 mL). The reaction solution was stirred to dissolve both copolymers, and the solution was taken through 3 freeze-pump-thaw cycles and back filled with nitrogen. The reaction was then sealed, heated to 120° C., and allowed to stir for 3.5 or 6 hours. The reaction is then precipitated into room temperature hexanes, and the product is separated and allowed to stir in 40° C. acetonitrile for 12 hours. The acetonitrile soluble fraction was removed and the insoluble product was then stirred in 45° C. cyclohexane for 18 hours. The cyclohexane soluble fraction was removed and the insoluble product was isolated. All products are dried overnight by vacuum.

Self-Initiated (EE): A dry glass tube equipped with a magnetic stir bar was charged with EE PMMAB4.28 copolymer (˜51 mg), E PSB2.98 (˜81 mg), and anhydrous dimethylformamide (1.4 mL). The reaction solution was stirred to dissolve both copolymers, and the solution was taken through 3 freeze-pump-thaw cycles and back filled with nitrogen. The reaction was then sealed, heated to 120° C., and allowed to stir for 8 hours. The reaction is then precipitated into room temperature hexanes, and the product is separated and allowed to stir in 40° C. acetonitrile for 12 hours. The acetonitrile soluble fraction was removed and the insoluble product was then stirred in 45° C. cyclohexane for 18 hours. The cyclohexane soluble fraction was removed and the insoluble product was isolated. All products are dried overnight by vacuum.

Both self-exchange and radical switch reactions signify AFT self-initiation. Dithiobenzoate end group thermolysis under self-exchange conditions in RAFT PMMAB samples result in AFT initiation seen in both the inhibited formation of MMA compared to literature, and the homogenization of the molar mass distribution. Follow-up experiments with externally initiated AFT corroborated that molar mass distributions are homogenized through the exchange of allyl sulfide linkages. The hypothesis that AFT is self-initiated through dithiobenzoate end group thermolysis is further confirmed by the creation of block copolymers formed by radical exchange between two types of BMDTO copolymers on heating. Comparable block copolymers were synthesized in externally initiated radical switch reactions where the external radical source, AIBN, began AFT. Given verification that AFT is successfully self-initiated by dithiobenzoate cleavage at elevated temperatures, these RAFT polymers were screened for their ability to undergo ultrasound induced AFT in the solid-state.

### Enhanced Immiscible Polymer Adhesion by Self-Initiated SonoAFT

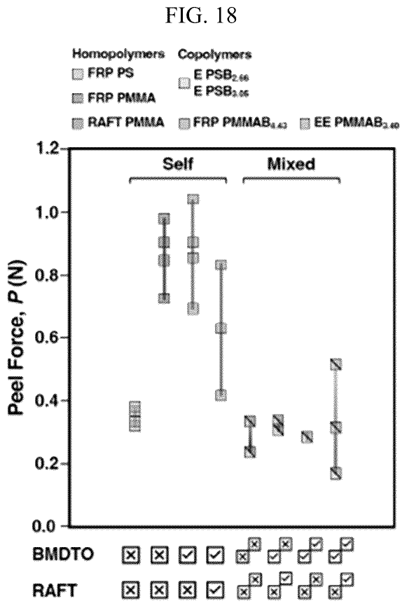

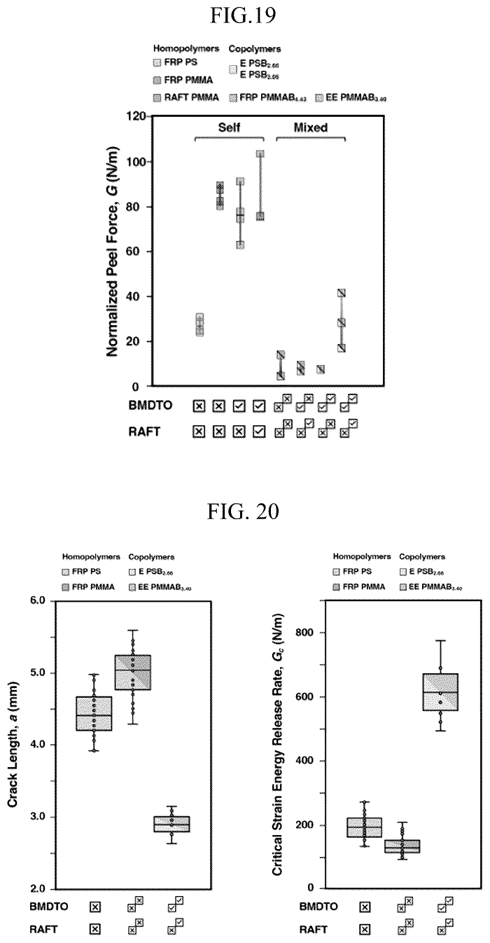

Experimental peel forces are shown in FIG. 18 as a function of weld type (self vs. mixed) and material type. The PMMA, PMMAB, and dithiobenzoate containing EE PMMAB self-welds supported the largest loads before reaching sustained peeling, while PS self-welds and all mixed welds surpassed critical loading conditions under much lighter loads. Accounting for peel angle and weld width, the normalized peel force reveals a potential differences between PS-PS self-welds and the series of mixed welds (FIG. 19).

Matching expectations, mixed welds without the components for AFT have the lowest normalized peel force, likely due to reduced interdiffusion during welding due to polymer immiscibility. However, mixed welds containing BMDTO across and dithiobenzoate groups at the interface have elevated normalized peel force comparable with PS self-welds.

In an effort to quantitatively assess of the USW capability of AFT active interfaces, welds were assessed by double cantilever beam testing, an established method for determining interfacial properties of glassy polymer adhesion. Results are shown in FIG. 20.

Gc data indicates a minor decrease in weld adhesion in the mixed PS-PMMA sample compared to the PS-PS sample. In contrast, the mixed weld containing allyl sulfide linkages and dithiobenzoate end groups has a higher Gc, surpassing both the PS-PMMA and PS-PS welded samples. These findings indicate an improvement in weld adhesion in the AFT active interface. Fracture toughness of PS-PS interfaces in literature (Gc˜20-60 N/m) are lower than our reported value (Gc˜200 N/m), while unmodified PS-PMMA interfaces (Gc˜50-80 N/m) are closer to our reported value (Gc˜130 N/m), where all samples were evaluated by double cantilever beam testing. The critical strain energy release rate of our AFT active interface (Gc˜600 N/m) is larger than values reported for both random (Gc˜150 N/m) and block copolymer reinforced PS-PMMA interfaces in literature (Gc˜200 N/m), where comparison samples were fabricated by melt pressing and also studied by double cantilever beam testing. Direct comparison of Gc values with literature is challenging, as the majority of previous work either discusses conventional thermal welds, assesses other properties of welded samples, or presents fracture in bulk materials.

Heightened adhesion between immiscible polymers by interfacial self-initiated sonoAFT was successfully visualized through peel and double cantilever beam experiments. While subject to many confounding variables, peel experiments show welds between immiscible polymers containing BMDTO and dithiobenzoate have higher peel forces than those without either BMDTO or RAFT end groups, or those lacking both. Double cantilever beam experiments illustrate improved adhesion in immiscible polymer welds by a notable increase in the critical strain energy release rate, Gc, in the weld containing both BMDTO and dithiobenzoate end groups relative to a weld between homopolymers of PS and PMMA. These promising results demonstrate the potential of self-initiated AFT in adhesion and motivate future research in other fusion bonding applications.

Additional experimental details follow.

All reactions were performed under dry nitrogen (flowed through a drierite column) following standard Schlenk techniques unless specifically indicated. Reactions carried out at room temperature correspond to temperatures between 20-22° C. The reaction temperatures reported in this work indicate the recorded temperature of the oil bath surrounding a stirring and submerged reaction vessel.

Materials: Reagent and solvent sources Unless otherwise stated, all reagents and solvents were used without further purification. 3-chloro-2-chloromethyl-1-propylene, absolute ethanol, 2,2′-azobis(2-methylpropionitrile), acryloyl chloride, ethyl chloroformate, triethyl amine, styrene, methyl methacrylate, 2-vinyl pyridine, deuterated chloroform (0.03 vol. % tetramethyl silane (TMS), 99.8% minimum deuteration degree, stabilized with silver), and basic alumina were purchased from Sigma Aldrich. Anhydrous toluene (99.8% with AcroSeal™) was purchased from Acros Organics. Potassium ethyl xanthate, ethylenediamine, sulfuric acid (conc.), 1,8-diazabicyclo[5.4.0]-7-undecene (98+%), alfa aesar inhibitor removal resin, 2-aminoisobutyric acid, sodium hydroxide (pellet), hydrochloric acid, butyl methacrylate, methyl acrylate, tetrahydrofuran, chloroform, hexanes, and methanol were purchased from Fisher Scientific.

AIBN purification: 2,2′-Azobis(2-methylpropionitrile) (AIBN) was purified by recrystallization in methanol three times before being dried under vacuum and stored between 1-4° C. Recrystallization was performed by preparing an over-saturated solution of AIBN in methanol at room temperature and gently heating the solution to 38° C. with stirring to achieve a uniform solution (clear without residue crude AIBN). The solution was then slowly cooled back to room temperature to foster crystallization.

Vinyl monomer purification: Vinyl monomers were stored between 1-4° C. Directly preceding use, monomer was dispensed into a vial and stirred gently with Alfa Aesar inhibitor removal resin for approximately 10 minutes. The monomer was then passed through a syringe plugged with glass wool and packed with basic alumina (˜equal amounts of alumina to monomer by weight). Filtered monomer is gravimetrically measured as dispensed into reaction vessel.

Precipitation: Following polymerization, radical scission, or radical chain extension reactions, the polymer solution was either evaporated or diluted with chloroform to achieve a dilution of approximately (50 mg/0.5 μmL). Larger scale reactions (>50 mg) were precipitated into a stirring beaker of the corresponding precipitation solvent (˜50 mL). Styrene and butyl methacrylate polymers were precipitated into methanol. In certain cases, butyl methacrylate precipitation resulted in a cloudy solution that required overnight to clarify (resulting in dense polymer rich layer). Methyl methacrylate, methyl acrylate, 2-vinyl-4,4-dimethyl azlactone, and 2-vinyl pyridine polymers were precipitated into hexanes. To avoid excessive loss when reactions were carried out <50 mg scale, the precipitation solvent was instead steadily added to the stirring polymer solution. Fine precipitates were collected by vacuum filtration using Whatman™ filter paper with a Büchner funnel. Products were dried under vacuum (˜5-15 Torr) at 100° C. (styrene, methyl methacrylate, 2-vinyl pyridine, 2-vinyl-4,4-dimethyl azlactone) or 50° C. (butyl methacrylate, methyl acrylate).

### Analytical Instrumentation and Methods

Nuclear Magnetic Resonance Spectroscopy (NMR): Nuclear magnetic resonance spectroscopy was conducted on a Bruker Avance III 500 MHz solution state instrument at room temperature, unless otherwise indicated. This instrument is equipped with a Prodigy® broadband probe. All experiments were conducted in deuterated chloroform solvent with TMS (0.03 vol %), unless otherwise stated. Chemical shifts (δ) are reported in ppm and referenced to residual chloroform peaks for ¹H NMR (δ 7.26 ppm) and ¹³C NMR (δ 77.2 ppm) spectra.

Attenuated Total Reflectance Fourier Transform Infrared Spectroscopy (ATR FTIR): ATR FT-IR spectral data was conducted on a Perkin Elmer Frontier FT-IR Spectrometer fitted with a Perkin Elmer Universal ATR Sampling Accessory inset. Samples were solution cast and dried onto the sampling stage to achieve contact between the sample and instrument.

Size Exclusion Chromatography (SEC): Molecular size was calculated from the permeation behavior of polymer analytes through either a dimethylformamide (DMF) or a tetrahydrofuran (THF) eluent column dependent on product solubility. DMF SEC was conducted using an Agilent 1260 Infinity series system fitted with a 5 μm guard column and a PL 5 μm mix D 1 column; a mobile DMF phase (0.01 M LiCl) was held at 50° C. and a flow rate of 1 mL/min, using toluene as a flow marker. THF SEC was conducted using an Agilent Technologies 1260 Infinity series system, equipped with two 5 μm mixed D columns, a 5 μm guard column, a PL Gel 5 μm analytical mixed-D column, with a flow rate of 1.0 mL/min and toluene as a flow marker. Both instruments are equipped with a refractive index detector, and the THF SEC was additionally equipped with a variable wavelength detector. Instruments were calibrated with polystyrene and polymethylmethacrylate standards. All samples were passed through a 0.4 m PTFE syringe filter before injection into the instrument. Molar mass values were calculated according to linear polystyrene calibration standards (1-350 kDa) for styrene, 2-vinyl 4,4-dimethyl azlactone, and 2-vinyl pyridine samples, and polymethylmethacrylate calibration standards (3-300 kDa) for methyl methacrylate, butyl methacrylate, and methyl acrylate samples.

Thermal Gravimetric Analysis (TGA) and Derivative Thermogravimetry (DTG): Thermal degradation behavior of samples (5-10 mg) were studied using a TA Instruments Q50 Thermogravimetric Analyzer under nitrogen flow (25.0 ml/min) with a ramp rate of 20° C./min to a maximum temperature of 500° C. Platinum sample pans were cleaned by butane torch prior to use. Thermal gravimetric (TGA) data expressed as weight % vs. temperature were converted to derivative thermogravimetry (DTG) curves by taking the derivative of the weight loss % with respect to time (when ramp rate is constant) and plotting versus temperature.

Differential Scanning Calorimetry (DSC): Thermal transitions were studied using a TA Instruments Q200 Differential Scanning Calorimeter equipped with a cooling system (temperature minimum=−80° C.). Samples (˜5 μmg) were sealed in hermetic aluminum pan and taken through three heating/cooling cycles ranging from −50 to 200° C. at a heating/cooling rate of 10° C./min. Reported Tg values were from the second heating scan and taken at the maximum absolute value of the derivative of heat flow with respect to temperature.

### Peel Experiments

Films were fabricated by solution casting (˜130 mg polymer/3 mL chloroform) in PTFE evaporating dishes (i.e., evaporating pan) where ˜1.5 μmL of solution covered an area with a ˜5 cm diameter. After casting, the pans were covered with a glass cover dish to prevent dust and other debris inside the fume hood from contaminating the sample surface, and to slow the evaporation of chloroform. After ˜30 minutes, the cover dishes were removed and films were solidified over an additional 45 μminutes. With the films solid enough to handle, they were peeled from the PTFE pans and sandwiched between two aluminum foil sheets and uniformly compressed under a weight of approximately 2 grams. This flattening step helped to generate flat samples with regular surfaces (i.e., minimized curvature from solvent evaporation process). After 60 minutes, polymer films were then cut into rectangular samples (12.5 μmm by 25 μmm), and dried overnight at room temperature under vacuum. Final film thicknesses ranged from 20 to 60 μm.

Films were overlapped and held together at one end and welded on the other end approximately 2-3 mm from the sample edge. Ultrasonic welding was conducted using a mounted hand-held 40 KHz 400 watt Ultra-Tek 40.4 ultrasonic welder, where amplitude was held at 50%, and samples were welded using a titanium cylindrical sonode 10 mm in diameter. Sample films were compressed and welded for approximately three seconds. Each sample was welded once.

Hanging weight peel experiments were conducted by adhering welded samples to a glass microscope slide (25 μmm by 75 μmm with a thickness of 1 mm) with double-sided tape. The sample was then inverted with the glass slide supported on either side of the sample. The bending arm (un-taped film) was fixed with a compressive clip that was used for incrementally loading weights onto the sample. The peel front was monitored in relation to the welded area of the sample by looking at the transparent glass backing. Samples were incrementally loaded with metal washers with care taken to ensure small loading changes. Once above a critical load, subtle, quasi-constant crack propagation was reached, and the corresponding load, peel angle (determined from photographs using ImageJ software), and weld width at the debonding front were recorded. As samples contained circular adhered areas, these conditions were satisfied when the debonding front approached the midpoint of the weld, and the adhered width was nearly constant.

Double cantilever beam experiments were also conducted. A white polystyrene sheet (˜0.238 mm in thickness, with total dimensions of 5 ft. by 8 ft.), manufactured by USA Industrials, was purchased from Fastenal (Fastenal part no. 923010688). Polystyrene plaques were fabricated from this single sheet by first cutting the sheet into manageable portions by a handsaw, then cut into strips by a bandsaw. The final dimensions of the plaques were too small to machine with the bandsaw, and were cut to size by scoring with a Dewalt utility single-blade knife, resulting in plaques of the final dimension of 10 mm by 75 μmm. The plaque edges were sanded to ensure clear field of view during double cantilever beam testing. Sample films were over lapped and held on one end and welded. Ultrasonic welding was conducted using a mounted hand-held 40 KHz 400 watt Ultra-Tek 40.4 ultrasonic welder, where amplitude was held at 50%, and samples were welded using a titanium cylindrical sonode 10 mm in diameter. Films were compressed and welded for three seconds at a time. Each sample was welded three times to span a welded length˜20 mm. Welded thin films of were then fixed to polystyrene plaques using a thin layer of quick setting cyanoacrylate glue (“Krazy glue,” super glue). Care is taken to ensure cyanoacrylate glue does not migrate from the intended interfaces, and independent experiments confirmed that cyanoacrylate adhesive (ethyl 2-cyanoacrylate) does not dissolve or diffuse through the polystyrene or polymethyl methacrylate films. The beginning of the welded area of the films is placed within 5 μmm of the plaque edge. With the cyanoacrylate adhesive applied, the welded sample and plaques are compressed and allowed to set for at least 10 minutes. Known distances are either indicated on the plaque edge or the plaque thickness itself is recorded and used to enable accurate crack measurements from the plane of focus during double cantilever beam testing.

Double Cantilever Beam Testing: The Stable Micro Systems texture analyzer is calibrated (with respect to height between outfitted fasteners) and the sample is then loaded into a mechanical fastening clamp and a razor blade (stainless steel, single edge razor blade with a thickness of 0.24 mm) is loaded into the moving arm of the texture analyzer by a mechanical fastener. Care is taken to ensure alignment between the razor blade and the welded interface. A Nikon camera is then set up in on a tripod in front of the texture analyzer and the plaque edge is placed in focus. A video is started and the razor blade moves a fixed velocity of 10 μm/s. Double cantilever experiments were analyzed by taking snap shots of the video when the crack was moving through the welded area and measuring the crack length using ImageJ software.

This disclosure further encompasses the following aspects.

Aspect 1: A polymer comprising repeating units derived from an ethylenically unsaturated monomer and a cyclic allyl sulfide, wherein the repeating units derived from the cyclic allyl sulfide are of the structure

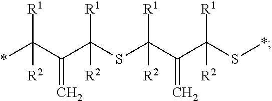

wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

Aspect 2: The polymer of aspect 1, wherein the ethylenically unsaturated monomer is a vinyl monomer, a styrenic monomer, a (meth)acrylate monomer, a (meth)acrylamide monomer, or an olefin.

Aspect 3: The polymer of aspect 1 or 2, wherein the repeating units derived from the cyclic allyl sulfide monomer are present in an amount of 0.1 to 50 mole percent, or 0.1 to 25 mole percent, or 0.1 to 15 μmole percent, or 0.5 to 15 μmole percent, or 0.7 to 13 mole percent.

Aspect 4: The polymer of any of aspects 1 to 3, wherein the ethylenically unsaturated monomer is a vinyl monomer.

Aspect 5: The polymer of any of aspects 1 to 3, wherein the ethylenically unsaturated monomer is a styrenic monomer.

Aspect 6: The polymer of any of aspects 1 to 3, wherein the ethylenically unsaturated monomer is a C₁₋₆ alkyl (meth)acrylate.

Aspect 7: The polymer of any of aspects 1 to 6, wherein the polymer does not comprise an ester or a thioester in the polymer backbone.

Aspect 8: The polymer of any of aspects 1 to 7, wherein R¹ and R² are each hydrogen.

Aspect 9: The polymer of any of aspects 1 to 7, wherein R¹ and R² are independently at each occurrence hydrogen or C₁₋₆ alkyl, preferably methyl or ethyl, more preferably methyl.

Aspect 10: The polymer of any of aspects 1 to 7, wherein at least one occurrence of R¹ and R² on a single carbon atom are taken together with the carbon atom to form a C═O.

Aspect 11: A method for the manufacture of the polymer of any of aspects 1 to 10, the method comprising: contacting an ethylenically unsaturated monomer, and a cyclic allyl sulfide of the formula

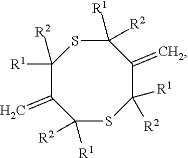

in the presence of a free radical initiator to provide the polymer; wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

Aspect 12: The method of aspect 11, wherein the method is a controlled free radical polymerization method.

Aspect 13: The method of aspect 11, wherein the method is an emulsion polymerization method, and wherein the polymer has a molecular weight that is greater than a corresponding polymer prepared using a non-emulsion free radical polymerization.

Aspect 14: A method for reprocessing the polymer of any of aspects 1 to 10, the method comprising: contacting the polymer with a thiol-containing compound in the presence of a free radical initiator to provide a polymeric chain scission product.

Aspect 15: The method of aspect 14, wherein the thiol-containing compound is a dithiol.

Aspect 16: The method of aspect 14 or 15, wherein the thiol-containing compound comprises an allyl dithiol.

Aspect 17: The method of any of aspects 14 to 16, wherein the polymeric chain scission product has a peak molecular weight (Mp) that is less than a peak molecular weight of the polymer; a molecular weight distribution (D) that is broader than a molecular weight distribution of the polymer; or both.

Aspect 18: The method of any of aspects 14 to 17, wherein the polymeric chain scission product has a peak molecular weight (Mp) that is 10 to 90%, preferably 10 to 50% of the peak molecular weight of the polymer.

Aspect 19: The method of any of aspects 14 to 18, wherein the polymeric chain scission product comprises at least one thiol end group.

Aspect 20: The method of any of aspects 14 to 19, further comprising contacting the polymeric chain scission product with an ethylenically unsaturated monomer, a cyclic allyl sulfide of the structure

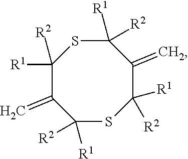

or a combination thereof in the presence of a free radical initiator to provide a chain-extended polymer product, wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

Aspect 21: The method of aspect 20, wherein the method further comprises contacting the polymeric chain scission product with the ethylenically unsaturated monomer and the cyclic allyl sulfide in the presence of the free radical initiator.

Aspect 22: The method of aspects 20 or 21, wherein the ethylenically unsaturated monomer is the same as the ethylenically unsaturated monomer of the polymer prior to chain scission.

Aspect 23: The method of aspects 20 or 22, wherein the ethylenically unsaturated monomer is different from the ethylenically unsaturated monomer of the polymer prior to chain scission.

Aspect 24: The method of any of aspects 20 to 23, wherein the chain-extended polymer product has a peak molecular weight that is 1.1 to 15 times the peak molecular weight of the polymeric chain scission product.

Aspect 25: The method of any of aspects 14 to 24, wherein the thiol-containing compound comprises three or more thiol groups, and the polymeric chain scission product is a crosslinked network.

Aspect 26: A method of welding a first substrate and a second substrate, the method comprising: contacting at least a portion of a first polymer substrate with at least a portion of a second polymer substrate; and subjecting the contacted portions of the first polymer substrate and the second polymer substrate to ultrasonication to provide a welded article; wherein the first polymer substrate and the second polymer substrate each comprise a polymer according to any of aspects 1 to 10, wherein the ethylenically unsaturated monomer of the first polymer substrate is selected such that a corresponding homopolymer is immiscible with a corresponding homopolymer of the ethylenically unsaturated monomer of the second polymer substrate, and wherein the polymer of the first polymer substrate, the second polymer substrate, or both comprise an end group that is capable of forming a radical species when subjected to ultrasonication.

Aspect 27: The method of aspect 26, wherein the welded article has increased peel strength relative to a corresponding welded article wherein the first polymer substrate and the second polymer substrate do not include repeating units derived from the cyclic allyl sulfide.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl.

Unless substituents are otherwise specifically indicated, each of the foregoing groups can be unsubstituted or substituted, provided that the substitution does not significantly adversely affect synthesis, stability, or use of the compound. “Substituted” means that the compound, group, or atom is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g, toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the total number of carbon atoms in the compound or group, including those of any substituents.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A polymer comprising repeating units derived from an ethylenically unsaturated monomer and a cyclic allyl sulfide, wherein the repeating units derived from the cyclic allyl sulfide are of the structure 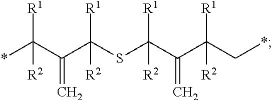
wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

2. The polymer of claim 1, wherein the ethylenically unsaturated monomer is a vinyl monomer, a styrenic monomer, a (meth)acrylate monomer, a (meth)acrylamide monomer, or an olefin.

3. The polymer of claim 1, wherein the repeating units derived from the cyclic allyl sulfide monomer are present in an amount of 0.1 to 50 mole percent.

4. The polymer of claim 1, wherein the ethylenically unsaturated monomer is a vinyl monomer, a styrenic monomer, or a C₁₋₆ alkyl (meth)acrylate monomer.

5. The polymer of claim 1, wherein the polymer does not comprise an ester or a thioester in the polymer backbone.

6. The polymer of claim 1, wherein R¹ and R² are each hydrogen.

7. The polymer of claim 1, wherein R¹ and R² are independently at each occurrence hydrogen or C₁₋₆ alkyl.

8. The polymer of claim 1, wherein at least one occurrence of R¹ and R² on a single carbon atom are taken together with the carbon atom to form a C═O.

9. A method for the manufacture of the polymer of claim 1, the method comprising:
contacting
an ethylenically unsaturated monomer, and
a cyclic allyl sulfide of the formula 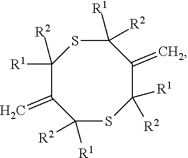
in the presence of a free radical initiator to provide the polymer;
wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

10. The method of claim 9, wherein the method is a controlled free radical polymerization method.

11. The method of claim 9, wherein the method is an emulsion polymerization method, and wherein the polymer has a molecular weight that is greater than a corresponding polymer prepared using a non-emulsion free radical polymerization.

12. A method for reprocessing the polymer of claim 1, the method comprising:
contacting the polymer with a thiol-containing compound in the presence of a free radical initiator to provide a polymeric chain scission product.

13. The method of claim 12, wherein the thiol-containing compound is a dithiol.

14. The method of claim 12, wherein the thiol-containing compound comprises an allyl dithiol.

15. The method of claim 12, wherein the polymeric chain scission product has a peak molecular weight (Mp) that is less than a peak molecular weight of the polymer;
a molecular weight distribution (Ð) that is broader than a molecular weight distribution of the polymer;
or both; and
wherein the polymeric chain scission product comprises at least one thiol end group.

16. The method of claim 12, further comprising contacting the polymeric chain scission product with an ethylenically unsaturated monomer, a cyclic allyl sulfide of the structure 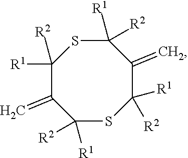
or a combination thereof in the presence of a free radical initiator to provide a chain-extended polymer product,
wherein R¹ and R² are independently at each occurrence hydrogen, a substituted or unsubstituted C₁₋₆ alkyl group, a halogen, or R¹ and R² on a single carbon atom are taken together with the carbon atom to form a C═O.

17. The method of claim 16, wherein the chain-extended polymer product has a peak molecular weight that is 1.1 to 15 times the peak molecular weight of the polymeric chain scission product.

18. The method of claim 12, wherein the thiol-containing compound comprises three or more thiol groups, and the polymeric chain scission product is a crosslinked network.

19. A method of welding a first substrate and a second substrate, the method comprising:
contacting at least a portion of a first polymer substrate with at least a portion of a second polymer substrate; and
subjecting the contacted portions of the first polymer substrate and the second polymer substrate to ultrasonication to provide a welded article;
wherein the first polymer substrate and the second polymer substrate each comprise a polymer according to claim 1,
wherein the ethylenically unsaturated monomer of the first polymer substrate is selected such that a corresponding homopolymer is immiscible with a corresponding homopolymer of the ethylenically unsaturated monomer of the second polymer substrate, and
wherein the polymer of the first polymer substrate, the second polymer substrate, or both comprise an end group that is capable of forming a radical species when subjected to ultrasonication.

20. The method of claim 19, wherein the welded article has increased peel strength relative to a corresponding welded article wherein the first polymer substrate and the second polymer substrate do not include repeating units derived from the cyclic allyl sulfide.
